(19) United States
(12) Patent Application Publication
(10) Pub. No.: US 2018/0280799 A1
(43) Pub. Date: Oct. 4, 2018

(54) GAME SYSTEM

(71) Applicant: BANDAI NAMCO ENTERTAINMENT INC., Tokyo (JP)

(72) Inventors: Kazuhito ICHIJO, Ichikawa-shi (JP); Satoshi MINAMIDATE, Tokyo (JP)

(73) Assignee: BANDAI NAMCO ENTERTAINMENT INC., Tokyo (JP)

(21) Appl. No.: 15/936,792

(22) Filed: Mar. 27, 2018

(30) Foreign Application Priority Data
Mar. 30, 2017 (JP) 2017-068399

(51) Int. Cl. A63F 13/58; A63F 13/795; A63F 13/35; A63F 13/87; A63F 13/847

(52) U.S. Cl. CPC A63F 13/58; A63F 13/795; A63F 2300/572; A63F 13/87; A63F 13/847; A63F 13/35

(57) ABSTRACT

A game system is configured to set a plurality of player characters, including a home player character and a specific player character managed by another player, in a deck on the basis of an instruction from a player, and when a specific player character of another player is selected as an execution character, adjust an execution parameter on the basis of relationship information indicating a relationship between the home player and the other player managing the specific player character.

Japanese Patent Application No. 2017-068399, filed on Mar. 30, 2017, is hereby incorporated by reference in its entirety.

### BACKGROUND OF THE INVENTION

The present invention relates to a game system, and so on.

Network systems known as social networking services (referred to hereafter as “SNS”), which provide users with community type services, are well-known conventionally, and in recent years it has become common to play games using the functions of an SNS.

In these types of games, relationships with other players may be reflected in the game, and in a conventional game system, for example, an advantageous effect within the game, such as improving an ability of a player character, is generated on the basis of the number of followers having a relationship with the player that enables the followers to peruse information and statuses relating to the player (Japanese Patent Application No. 2016-123756).

However, in the game system described in the above publication and so on, although relationships with other players are reflected in the game, these relationships are limited to followers and so on, which are of limited use, and are established without player-to-player communication, and therefore room for improvement remains in terms of utilizing the functions of an SNS to enliven a game and increase the number of users of the game.

### SUMMARY

The invention provides a game system and so on with which players can be provided with a motive for communicating actively with each other, the number of participants in a game can be increased and the game can be enlivened, and interest in the game can be increased by incorporating relationship building with other players as a game element.

According to a first aspect of the invention, there is provided a game system for executing a game using a relationship between a player and another player, the game system comprising:

management means for managing storage means, the storage means storing, for each player, relationship information indicating the relationship of the player to the other player, and player character information which is information relating to player characters that can be used by each player in the game and respectively have given game parameter values prescribed thereto;

selecting means for executing selection processing to select, on the basis of an instruction from the player, a player character to be used in the game as an execution character from among a plurality of player characters that are stored in the storage means and can be used by the player, the plurality of player characters including, as a specific player character, a player character that is managed by the other player;

setting means for setting the game parameter value stored for each selected execution character at a given game parameter value for executing the game, and using the set game parameter value as an execution parameter value; and

game control means for executing the game on the basis of the set plurality of execution characters and the set execution parameter values thereof,

wherein the relationship with the other player includes a following relationship which is a relationship in which predetermined information or statuses relating to the other player can be viewed as a function of the game, and a follower relationship which is a relationship in which the other player is allowed to view predetermined information or statuses relating to a home player as a function of the game, and

wherein, when the specific player character is selected as the execution character, the setting means adjusts the execution parameter value on the basis of the relationship information indicating the following relationship or the follower relationship between the home player who is the player who issues the selection instruction during the selection processing, and the other player managing the specific player character.

According to a second aspect of the invention, there is provided a method for executing a game using a relationship between a player and another player, the method comprising:

managing storage means, the storage means storing, for each player, relationship information indicating the relationship of the player to the other player, and player character information which is information relating to player characters that can be used by each player in the game and respectively have given game parameter values prescribed thereto;

executing selection processing to select, on the basis of an instruction from the player, a player character to be used in the game as an execution character from among a plurality of player characters that are stored in the storage means and can be used by the player, the plurality of player characters including, as a specific player character, a player character that is managed by the other player;

setting the game parameter value stored for each selected execution character at a given game parameter value for executing the game, and using the set game parameter value as an execution parameter value; and

executing the game on the basis of the set plurality of execution characters and the set execution parameter values thereof,

wherein the relationship with the other player includes a following relationship which is a relationship in which predetermined information or statuses relating to the other player can be viewed as a function of the game, and a follower relationship which is a relationship in which the other player is allowed to view predetermined information or statuses relating to a home player as a function of the game, and

wherein, when the specific player character is selected as the execution character, the execution parameter value is adjusted on the basis of the relationship information indicating the following relationship or the follower relationship between the home player who is the player who issues the selection instruction during the selection processing, and the other player managing the specific player character.

### BRIEF DESCRIPTION OF THE OF THE SEVERAL VIEWS OF THE DRAWING

FIG. 1 is a diagram illustrating an example of a configuration of a game system according to one embodiment of the invention.

FIG. 2 is a functional block diagram illustrating an example of a configuration of a server device according to one embodiment of the invention.

FIGS. 3A and 3B illustrate examples of player information including game history information, stored in a storage section according to one embodiment of the invention.

FIG. 4 is a functional block diagram illustrating an example of a configuration of a terminal device according to one embodiment of the invention.

FIGS. 5A and 5B illustrate examples of an outer appearance of the terminal device according to one embodiment of the invention.

FIG. 6 illustrates adjustment of an execution parameter during processing for setting an execution character according to one embodiment of the invention.

FIG. 7 illustrates parameter setting processing according to one embodiment of the invention.

FIG. 8 illustrates parameter setting processing according to one embodiment of the invention.

FIG. 9 illustrates parameter setting processing according to one embodiment of the invention.

FIG. 10 illustrates parameter setting processing according to one embodiment of the invention.

FIG. 11 illustrates parameter setting processing according to one embodiment of the invention.

FIG. 12 illustrates parameter setting processing according to one embodiment of the invention.

FIG. 13 illustrates display control processing executed in relation to status information indicating a relationship between a player and another player according to one embodiment of the invention.

FIG. 14 illustrates display control processing for sorting and displaying relationship information on the basis of an execution parameter value according to one embodiment of the invention.

FIG. 15 is a flowchart illustrating player character selection and setting processing executed by the terminal device to set a plurality of player characters in a deck, according to one embodiment of the invention.

FIG. 16 is a flowchart illustrating player character selection and setting processing executed by the terminal device to set a plurality of player characters in the deck, according to one embodiment of the invention.

### DETAILED DESCRIPTION OF THE EMBODIMENT

(1) According to one embodiment of the invention, there is provided a game system for executing a game using a relationship between a player and another player, the game system including:

management means for managing storage means, the storage means storing, for each player, relationship information indicating the relationship of the player to the other player, and player character information which is information relating to player characters that can be used by each player in the game and respectively have given game parameter values prescribed thereto;

selecting means for executing selection processing to select, on the basis of an instruction from the player, a player character to be used in the game as an execution character from among a plurality of player characters that are stored in the storage means and can be used by the player, the plurality of player characters including, as a specific player character, a player character that is managed by the other player;

setting means for setting the game parameter value stored for each selected execution character at a given game parameter value for executing the game, and using the set game parameter value as an execution parameter value; and

game control means for executing the game on the basis of the set plurality of execution characters and the set execution parameter values thereof,

wherein the relationship with the other player includes a following relationship which is a relationship in which predetermined information or statuses relating to the other player can be viewed as a function of the game, and a follower relationship which is a relationship in which the other player is allowed to view predetermined information or statuses relating to a home player as a function of the game, and

wherein, when the specific player character is selected as the execution character, the setting means adjusts the execution parameter value on the basis of the relationship information indicating the following relationship or the follower relationship between the home player who is the player who issues the selection instruction during the selection processing, and the other player managing the specific player character.

According to this configuration, in the above embodiment, when the game is executed and a player character of the other player is used as a ghost character, for example, an execution parameter value that is advantageous in terms of advancing the game can be set on the basis of the relationship (more specifically, the follower relationship, the following relationship, a friendship in which mutual follower and following relationships exist, or the like) with the other player within the game, and as a result, an advantageous effect can be acquired during the game.

In the above embodiment, therefore, in order to acquire an advantageous effect during the game, relationships within the game must be built with other players.

Hence, in the above embodiment, communication with other players for the purpose of acquiring an advantageous effect can be promoted.

As a result, in the above embodiment, the number of participants in the game can be increased and the game can be enlivened, and interest in the game can be increased by incorporating relationship building with other players as a game element.

Note that the “plurality of player characters that can be used by the player” are player characters that are owned by each of the players and can be selected by each player so as to be set in a deck or the like, for example, and used in the game.

In particular, the specific player character is a player character that is managed (owned) by another player rather than being managed (owned) by the home player.

Further, “selecting a player character to be used in the game as an execution character” means selecting a player character that is to appear in a deck or the like in a game such as a battle game or an RPG, for example.

The “execution parameter” may be a game parameter set for each of the plurality of execution characters set in the deck or the like, or a game parameter corresponding to a team formed from the execution characters set in the deck or the like.

More particularly, examples of the game parameter include:

(A) the number of points (a score, in-game currency, a physical strength value, or an experience value) used in the game and given out to a team formed in the game from the player and the plurality of execution characters, or to each specific player character set as an execution character;

(B) an ability value (an attacking ability, a defensive ability, or a winning probability) of the team or an ability value employed when the specific player character executes the game; or

(C) a value obtained by adjusting (correcting) the value of (A) or (B).

Furthermore, “adjusting the execution parameter value” includes correcting the game parameter value set individually for each player character, including the specific player character (also including an item with which the player character is equipped), or modifying the game parameter value to another value, and correcting an overall game parameter value set on the basis of the respective game parameter values of the execution characters or modifying the overall game parameter value to another value.

In addition to the above, the “predetermined information or statuses relating to the other player (the home player)” includes information indicating attributes of the other player, such as gender and area of residence, various types of information such as a game level and a most recent game execution time of the other player, a game environment (for example, a login status, a battle status, or a status indicating execution of a predetermined stage such as a bonus stage) of the other player (the home player), and customizable statuses such as operation icons, player icons, and arrangements (including decorations) thereof.

(2) In the game system described above,

the execution parameter may be a game parameter relating to the specific player character selected as the execution character.

According to this configuration, in the above embodiment, when the game is executed and a player character of the other player is used as a ghost character, for example, the execution parameter value that is advantageous in terms of advancing the game can be adjusted on the basis of the relationship (for example, a friendship including follower and following relationships) with the other player within the game, and as a result, an advantageous effect can be acquired during the game.

Accordingly, in the above embodiment, communication with other players for the purpose of acquiring an advantageous effect can be promoted.

Note that the “game parameter relating to the specific player character” includes the number of points or an ability value relating to the specific player character.

(3) In the game system described above,

when the specific player character is selected as the execution character, the setting means may aggregate given numerical values relating to the following relationship or the follower relationship between the player and the other player managing the specific player character set as the execution character, the following relationship or the follower relationship being stored in the storage means, and adjust the execution parameter on the basis of the aggregation result.

According to this configuration, in the above embodiment, when the execution characters on the team used to execute the game, such as the deck, for example, include a large number of specific player characters managed by other players who have close ties, such as following relationships and follower relationships (including friendships), with each other, the execution parameters relating to these execution characters can be adjusted in an advantage direction for the player.

Hence, according to the above embodiment, communication with other players for the purpose of acquiring an advantageous effect in the game can be promoted.

Note that the given numerical value may be a numerical value aggregated in relation to a ratio or the number of other players having a following relationship or a follower relationship, including a friendship, or the like, for example.

(4) In the game system described above,

the relationship information may include supplementary information for obtaining a period in which the following relationship or the follower relationship has been established, and

when the specific player character is selected as the execution character, the setting means may obtain the supplementary information relating to the following relationship or the follower relationship between the home player and the other player managing the specific player character, obtain the period in which the relationship has been established on the basis of the obtained supplementary information, and adjust the execution parameter value on the basis of the relationship indicated by the relationship information and the obtained period.

According to this configuration, in the above embodiment, the value of the game parameter can be modified in accordance with the period in which the follower, following, or other relationship has been established, and therefore, when, among identical relationships, a relationship has been established for a long period, for example, the value of the execution parameter, such as the game parameter, relating to the specific player character set as the execution character can be adjusted to a value at which an advantageous effect, such as an improved ability, can be acquired.

Further, in the above embodiment, communication based on the game played between players must be executed actively in order to set the value of the execution parameter at a more advantageous value.

In other words, in the above embodiment, by communicating actively with other players, a parameter enabling acquisition of an advantageous effect during the game can be obtained spontaneously, and as a result, cooperation with other players and use of player characters managed by other players can be promoted.

Hence, according to the above embodiment, a motive for communicating actively with other players can be provided.

Note that the supplementary information includes the time at which the follower or following relationship was established (including the time at which the friendship was established), and information indicating the establishment period (referred to hereafter as “period information”). Further, the period information is calculated and updated at predetermined timing intervals after the relationship is established.

(5) In the game system described above,

the storage means may store, for each player, history information indicating a past playing history with other players having the following relationship or the follower relationship with each player, and

when the specific player character is selected as the execution character, the setting means may obtain the history information between the home player and the other player managing the specific player character, and adjust the execution parameter value on the basis of the following relationship or the follower relationship and the playing history indicated by the history information.

According to this configuration, in the above embodiment, when a player cooperates at least a predetermined number of times with another player with whom a relationship such as a follower relationship or a following relationship (including a friendship) exists or executes a game using a player character of the other player at least a predetermined number of times or the like, for example, and the specific player character managed by the other player is set as an execution character, the execution parameter, such as the game parameter, relating to the specific player character can be set at a value at which an improved ability or an advantageous effect is acquired.

Further, in the above embodiment, communication based on the game played between the players must be executed actively in order to set the value of the execution parameter at a more advantageous value.

In other words, in the above embodiment, by communicating actively with other players, a parameter enabling acquisition of an advantageous effect during the game can be obtained spontaneously, and as a result, cooperation with other players and use of player characters managed by other players can be promoted.

Hence, according to the above embodiment, a motive for communicating actively with other players can be provided.

Note that the “history information indicating the past player history” includes various types of information, such as a login time to the game, a total game playing time, the number of times a player has participated in the same event as another player during a past game, and the time of participation in the event, contact with another player while participating in the same game at the same time, the content of a message (including a standard message such as “Good job!”) sent to another player during a game and the number of sent messages, the content of a message received from another player and the number of received messages, and the number of times a player character of another player is used.

(6) The game system described above may further include:

specifying means for executing specification processing at a given timing on the basis of history information relating to games of each of the players, the history information being stored in the storage means, to specify another player who satisfied a given condition during a past game with a relevant player; and

registering/updating means for registering or updating the relationship information indicating the relationship between the home player and the other player who satisfied the given condition in the storage means as the following relationship in accordance with the given condition.

According to this configuration, in the above embodiment, registration of a following relationship (also including a friendship), which normally requires an operation and the inclination of the other player, can be executed automatically on the basis of the game history. Therefore, relationships with other players with whom a relationship is desired can be covered by achievements in the game, and as a result, a procedure that is troublesome for the player can be eliminated.

Note that the given timing is a timing during the game, such as the end of a battle game or a timing at which the game level is increased, for example, this timing being prescribed in a program, or a predetermined time of day such as 24:00 each day.

Further, when the specification processing is executed during the game played by the respective players, the “relevant player” indicates a player playing the game on whom the specification processing is executed, and when the specification processing is executed on all of the players participating in (registered in) the game, the “relevant player” includes all of the players.

Furthermore, the “given condition” includes various conditions, for example:

(A) participating in the same event as the relevant player at least a predetermined number of times;

(B) contacting the other player during a game at least a predetermined number of times;

(C) transmitting a specific message (including a standard message such as “Good job!”) to the other player, or transmitting a message at least a predetermined number of times;

(D) receiving a specific message from the other player, or receiving a message at least a predetermined number of times;

(E) using a player character of the home player at least a predetermined number of times; and

(F) using a player character of the other player at least a predetermined number of times.

(7) The game system described above may further include display control means for displaying a plurality of specific player characters on a game screen on the basis of a given instruction, and

the display control means may sort the plurality of specific player characters in descending order of an adjusted value of the execution parameter of each specific player character, and display the plurality of sorted specific player characters on the game screen.

According to this configuration, in the above embodiment, when specific player characters are set as execution characters, the adjusted values of the execution parameters can be compared easily, enabling an improvement in player convenience.

Note that the “given instruction” may be an instruction issued by the player by performing an operation or an instruction issued during the game processing and prescribed by the program, such as an instruction issued when setting the execution characters, for example.

(8) The game system described above may further include display control means for displaying, on a game screen, the relationship information indicating the relationship between the player and the other player managing the specific player character in association with the specific player character.

According to this configuration, in the above embodiment, when specific player characters are displayed on the game screen, such as when specific player characters are set as execution characters or when candidate other players and the specific player characters provided by these other players are displayed during relationship information registration, the player can be provided with the relationship information (information indicating the type of relationship, such as a following relationship or a follower relationship, for example) indicating the relationships with the other players managing the specific player characters.

Hence, according to the above embodiment, each player can be prompted to determine whether a specific player character will be advantageous during the game simply by displaying the specific player characters, enabling an improvement in player convenience.

(9) In the game system described above, when a given instruction issued in relation to the specific player character is detected, the display control means may display, on the game screen, information relating to a status of the relationship of the other player managing the specific player character.

According to this configuration, in the above embodiment, the player can be provided with the relationship information (information indicating the type of relationship, such as a following relationship or a follower relationship, for example) indicating the relationships with the other players managing the specific player characters when setting a specific player character as an execution character, after setting the specific player character as an execution character, and so on, enabling an improvement in player convenience.

Note that the “given instruction” may be an instruction issued by the player by performing an operation or an instruction issued during the game processing and prescribed by the program, such as an instruction executed to advance the game, for example a given action or event based on the game (in other words, an instruction executed in accordance with the program), for example.

Further, the “information relating to a status of the relationship” includes information relating to the relationships of the other player managing the specific player character with different players to the other player, such as the number of players following the other player, the number of players followed by the other player, and so on.

(10) In the game system described above, when the specific player character is selected as the execution character, the setting means may adjust the execution parameter value which relates to an ability of the specific player character, in accordance with the following relationship or the follower relationship between the home player and the other player managing the specific player character.

According to this configuration, in the above embodiment, the importance of the game parameter can be set by adjusting the execution parameter to a value at which an advantageous effect can be acquired in accordance with the type of relationship with the other player and so on.

For example, in the above embodiment, when the relationship with another player managing an execution character is a following relationship in which the home player follows the other player, the value of the execution parameter, according to which the ability of a normal execution character is a multiple of 1, can be modified to a multiple of 1.5.

Further, for example, in the above embodiment, when the relationship indicates that the other player is a follower of the home player, the value of the execution parameter, according to which the ability of a normal execution character is a multiple of 1, can be modified to a multiple of 2.

In other words, in the above embodiment, players are required to communicate with each other actively in order to acquire a larger number of friendship registrations, which are advantageous for the game, and therefore communication between players can also be used as a game element.

Note that the value of the execution parameter may be modified in stages according to the following relationship or follower relationship between the home player and the other player. For example, the value of the execution parameter is modified (increased in order of following relationship and follower relationship or, when friendships are also included, in order of following relationship, follower relationship, and friendship) to a value at which a more advantageous effect is generated in order of following relationship and follower relationship (or in order of following relationship, follower relationship, and friendship).

Further, the “ability” includes abilities required in a battle game, such as attacking power and defensive power, and also characteristics of the execution character, such as agility and jumping ability.

(11) In the game system described above, when the specific player character is selected as the execution character, the setting means may vary a characteristic relating to an ability of the execution character which is determined by the execution parameter, in accordance with the following relationship and the follower relationship between the home player and the other player managing the specific player character.

According to this configuration, as described above, a characteristic that relates to an ability of the execution character and is defined by the execution parameter can be varied in accordance with the type of relationship with the other player and so on, and as a result, the ability of the execution character can itself be modified.

For example, in the above embodiment, when the relationship with the other player managing the execution character is the following relationship, the ability of the execution character can be modified such that the execution character can attack more frequently or execute consecutive attacks, and when the relationship with the other player managing the execution character is the follower relationship, the ability of the execution character can be modified such that the execution character can defend more frequently or with a higher success rate.

Hence, in the above embodiment, the characteristics of the execution character can also be varied according to following relationship and follower relationship registrations and so on, and in so doing, communication with other players can be introduced as a strategic element of the game, leading to increased interest in the game.

Note that the “characteristic relating to an ability” includes attack frequency, defense frequency, number of consecutive attacks, defense success rate, and so on.

(12) In the game system described above, the setting means may obtain the number of players having the following relationship or the follower relationship with the other player managing the specific player character selected as the execution character, and adjust the execution parameter value, which relates to an ability of the specific player character, in accordance with the relationship type, namely the following relationship or the follower relationship, and the obtained number of players.

According to this configuration, in the above embodiment, the value of the execution parameter relating to the relevant specific player character can be adjusted in accordance with an ability value based on information indicating a specific relationship, such as the number of followers, which includes the number of registered friends, and therefore a game element can be incorporated into selecting specific player characters on the basis of the relationship information, or in other words determining the players from which the player characters are selected, leading to increased interest in the game.

Note that when the execution parameter denotes an ability of an execution character or an overall ability of a plurality of player characters (an ability of the team set in the deck, for example), the “value at which the advantageous effect increases” indicates a value at which the ability increases, when the game parameter denotes the number of points, the “value at which the advantageous effect increases” indicates an increased number of points, and when the execution parameter indicates a winning probability, the “value at which the advantageous effect increases” indicates a value at which an increased probability is obtained.

(13) In the game system described above, when two or more game parameters defining abilities of the specific player character are set for each specific player character,

the setting means may determine a game parameter to be adjusted as the execution parameter from the two or more game parameters in accordance with the relationship type, namely the following relationship or the follower relationship, of the relationship between the home player and the other player managing the specific player character set as the execution character.

According to this configuration, in the above embodiment, at least one game parameter to be adjusted can be determined from among two or more game parameters in accordance with an attribute of the specific player character, whereupon the determined game parameter is adjusted, or an adjustment range of the execution parameter can be varied in accordance with an attribute of the specific player character, and as a result, a game element can be incorporated likewise into selecting specific player characters as execution characters. Note that the numerical value adjustment range also includes “0”, indicating no adjustment.

(14) In the game system described above, a time at which each player executed a game may be stored in the storage means as access time information, and

when the specific player character is selected as the execution character, the setting means may specify another player with respect to whom the time indicated by the access time information satisfies a given condition, set a degree of priority of the specific player character managed by the specified other player to be higher than a degree of priority of another specific player character, and display the specific player characters on a game screen on the basis of the set degrees of priority.

According to this configuration, in the above embodiment, a specific player character of a player who is active during execution of the game can be set easily, and as a result, players can execute the game with fewer difficulties and improved convenience.

Note that the “given condition” is satisfied when, for example, the game was executed at most a predetermined time (three hours, for example) prior to the current time.

Further, “display . . . on the basis of degrees of priority” means displaying specific player characters having a higher degree of priority in locations on the game screen that the player can easily see, such as the top of the game screen, and displaying specific player characters having a lower degree of priority in locations on the game screen that are more difficult to see.

(15) According to one embodiment of the invention, there is provided a method for executing a game using a relationship between a player and another player, the method including:

managing storage means, the storage means storing, for each player, relationship information indicating the relationship of the player to the other player, and player character information which is information relating to player characters that can be used by each player in the game and respectively have given game parameter values prescribed thereto;

executing selection processing to select, on the basis of an instruction from the player, a player character to be used in the game as an execution character from among a plurality of player characters that are stored in the storage means and can be used by the player, the plurality of player characters including, as a specific player character, a player character that is managed by the other player;

setting the game parameter value stored for each selected execution character at a given game parameter value for executing the game, and using the set game parameter value as an execution parameter value; and

executing the game on the basis of the set plurality of execution characters and the set execution parameter values thereof,

wherein the relationship with the other player includes a following relationship which is a relationship in which predetermined information or statuses relating to the other player can be viewed as a function of the game, and a follower relationship which is a relationship in which the other player is allowed to view predetermined information or statuses relating to a home player as a function of the game, and

wherein, when the specific player character is selected as the execution character, the execution parameter value is adjusted on the basis of the relationship information indicating the following relationship or the follower relationship between the home player who is the player who issues the selection instruction during the selection processing, and the other player managing the specific player character.

According to this configuration, in the above embodiment, when the game is executed and a player character of the other player is used as a ghost character, for example, an execution parameter value that is advantageous in terms of advancing the game can be set on the basis of the relationship (more specifically, the follower relationship, the following relationship, a friendship in which mutual follower and following relationships exist, or the like) with the other player within the game, and as a result, an advantageous effect can be acquired during the game.

In other words, in the above embodiment, relationships within the game must be built with other players in order to acquire an advantageous effect during the game.

In the above embodiment, therefore communication with other players for the purpose of acquiring an advantageous effect can be promoted.

As a result, in the above embodiment, the number of participants in the game can be increased and the game can be enlivened, and interest in the game can be increased by incorporating relationship building with other players as a game element.

Embodiments of the invention will be described below. Note that the embodiments described below do not unduly limit the scope of the invention as stated in the claims. Note also that all of the elements described below in connection with the following embodiments should not necessarily be taken as essential elements of the invention.

### 1. Game System

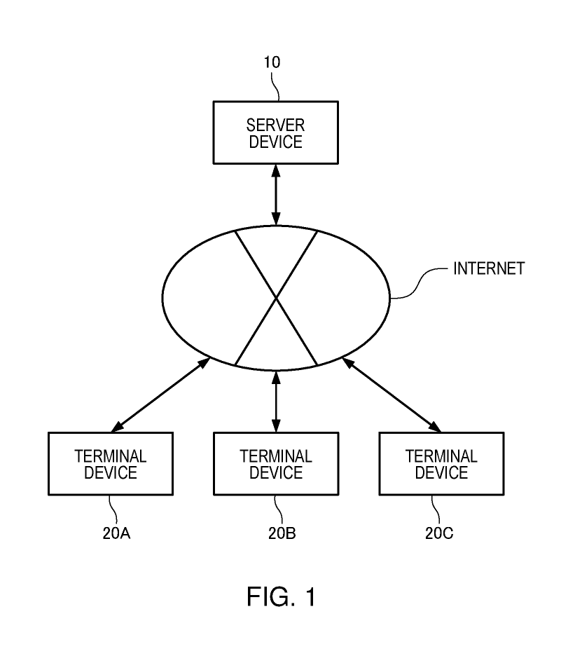

First, an outline and a schematic configuration of a game system 1 according to one embodiment of the invention will be described using FIG. 1. Note that FIG. 1 is a diagram illustrating an example of the configuration of the game system 1.

As illustrated in FIG. 1, the game system 1 is configured so that a server device 10 that provides a game service and a terminal device 20 (terminal devices 20A, 20B, and 20C, for example) can be connected to the Internet (an example of a network).

A user can play a game transmitted from the server device 10 through the Internet by accessing the server device 10 from the terminal device 20. The user can also communicate with another player by accessing the server device 10 from the terminal device 20.

The server device 10 is an information processing device capable of providing a service that allows the user to play the game using the terminal device 20, which is connected communicably to the server device 10 through the Internet. The server device 10 also functions as an SNS server that provides a communication type service.

More particularly, the server device 10 is an information processing device that provides a service allowing a plurality of users to communicate with each other, and is configured to provide a game known as a social game, which is played using an operating environment (an application programming interface (API), a platform, or the like) of an SNS provided thereby.

The server device 10 is configured to provide a game that is provided on a web browser of the terminal device 20, for example a browser game (a game that is activated simply by opening a website on which the game is installed using the web browser) created in various languages such as HTML, FLASH, CGI, PHP, shockwave, Java (registered trademark) applet, or JavaScript (registered trademark), for example.

Note that social games differ from existing online games in that social games include games that do not require dedicated client software and can be played using only a web browser and an SNS account.

The server device 10 may also provide an online game in which a terminal (a smartphone, a personal computer, a game device, or the like) can connect to a terminal of another player through a network so that the terminals can play the same game at the same time online so as to share the progress of the game, and may also provide a game in which the game can be executed by the individual terminal devices 20 and specific processing of the game can be executed in conjunction with the server device 10.

The server device 10 may be constituted by a single device or processor, or a plurality of devices or processors.

Information such as billing information, game information, and player information 146 is stored in a storage area (a storage section 140 to be described below) of the server device 10. Note, however, that this information may be stored in a database (in a broad sense, a storage device or a memory) that is connected to the server device 10 through a network (an intranet or the Internet).

Furthermore, in this embodiment, during cooperation with another player (when using a player character of another player, for example), the server device 10 receives input information based on an operation performed by the user (a player playing the game, for example) of the terminal device 20, and executes game processing for cooperating with the other player on the basis of the received input information.

In this case, the server device 10 transmits a game processing result to the terminal device 20, and the terminal device 20 executes various processing for providing the terminal device 20 with the game processing result received from the server device 10 so that the user can view the result.

The terminal device 20 is an information processing device such as a smartphone, a mobile phone, a PHS, a computer, a game device, a PDA, a portable game machine, an image generation device, or the like, which can connect to the server device 10 through a network such as the Internet (WAN) or a LAN. Note that a communication line between the terminal device 20 and the server device 10 may be wired or wireless.

Further, the terminal device 20 either executes the game processing using a game program provided by the server device 10 or obtains game control information subjected to game processing by the server device 10, and executes the game on the basis of the executed game processing or the obtained game control information.

Furthermore, the terminal device 20 is provided with a web browser that allows the user to view a web page (HTML format data). More specifically, the terminal device 20 has a communication control function for communicating with the server device 10, a web browser function for implementing display control using data (web data, data created in an HTML format, and so on) received from the server device 10 and transmitting data representing an operation performed by the user to the server device 10, and so on. The terminal device 20 may execute various types of processing for providing the user with a game screen and allowing the user to play the game.

More specifically, the terminal device 20 is configured such that during cooperation with another player (when using a player character of another player, for example), the game is executed thereby using the API either to cause the server device 10 functioning as an SNS server to perform predetermined processing or to obtain the player information 146 managed by the server device 10 functioning as an SNS server. Note that the terminal device 20 may execute predetermined game processing by obtaining the game control information provided by the server device 10, and execute the game on the basis of the game processing.

### 2. Server Device

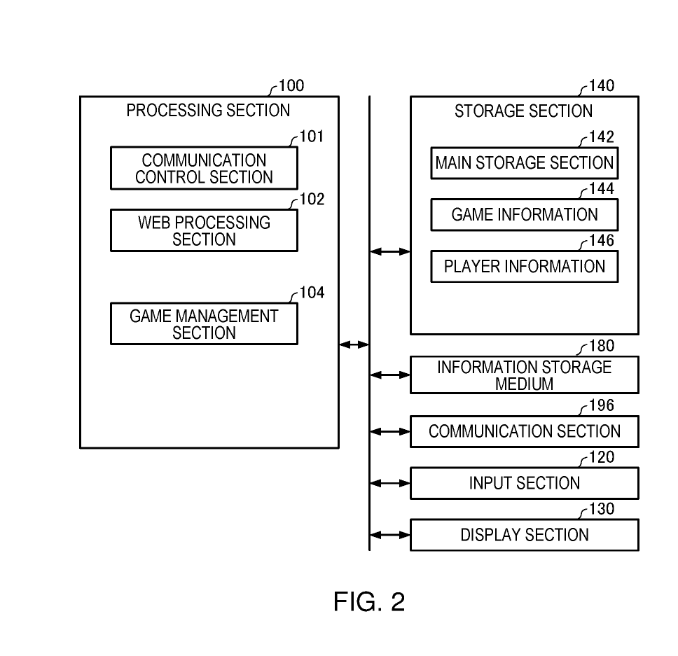

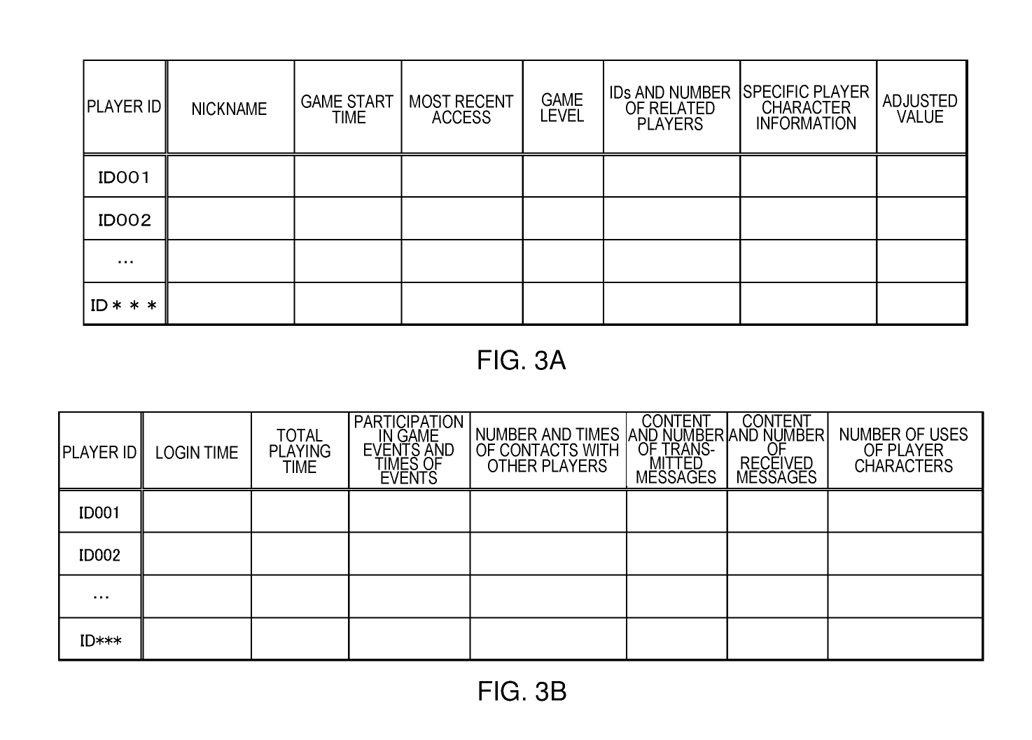

Next, the server device 10 according to one embodiment of the invention will be described using FIG. 2 and FIGS. 3A and 3B. Note that FIG. 2 is a functional block diagram illustrating the server device 10, while FIGS. 3A and 3B are examples of the player information 146 including game history information stored in the storage section 140. Further, the server device 10 may be configured such that some of the constituent elements (sections) shown in FIG. 2 are omitted.

The server device 10 includes an input section 120 used for input by an administrator and so on, a display section 130 for implementing predetermined display, an information storage medium 180 storing predetermined information, a communication section 196 that communicates with the terminal device 20 and other devices, a processing section 100 that mainly executes processing relating to the provided game, and the storage section 140 that mainly stores various types of data used in the game.

The input section 120 is used by a system administrator or the like to input game settings, other necessary settings, and data. The input section 120 is constituted by a mouse, a keyboard, or the like, for example.

The display section 130 displays an operation screen used by the system administrator. The display section 130 is constituted by a liquid crystal display or the like, for example.

The information storage medium 180 (a computer-readable medium) stores a program, data, and the like. A function of the information storage medium 180 is realized by an optical disk (a CD or a DVD), a magneto-optical disk (an MO), a magnetic disk, a hard disk, magnetic tape, a memory (a ROM), or the like.

The communication section 196 performs various types of control for communicating with the outside (for example, a terminal, another server, or another network system). A function of the communication section 196 is realized by hardware such as various types of processors or a communication ASIC, a program, or the like.

The storage section 140 serves as a work area for the processing section 100, the communication section 196, and so on. A function of the storage section 140 is realized by a RAM (a VRAM) or the like. Note that the information stored in the storage section 140 may be managed using a database. Further, the storage section 140 may serve as storage means, for example.

Furthermore, the storage section 140 includes a main storage section 142 that functions mainly as a work area. Game information 144 representing information relating to the provided game, the player information 146 representing information relating to respective players, history information 148 representing playing histories of the respective players, and various other types of information necessary for game calculations are stored in the storage section 140.

As well as information relating to the provided game, data of a list of players (referred to hereafter as a “player list”) who have registered to participate in the game and downloaded the corresponding game program and are now executing the game program are stored in the game information 144.

The player list includes data of a list of player IDs used to recognize other players, such as player IDs (including an ID allocated in accordance with the wishes of the player) allocated upon initial registration with the game or the service that controls the game.

Information relating to each player, information relating to specific player characters that can be selected by each player as player characters (referred to hereafter as “execution characters”) set in a deck in order to execute the game, and information (referred to as “history information” hereafter) relating to the game history of each player are stored in the player information 146.

More specifically, as illustrated in FIG. 3A, the player information 146 includes, for each player, information relating to the respective players and information relating to player characters (referred to hereafter as “specific player characters”) that can be set as execution characters of other players (or in other words, can be used by other players), among the player characters managed (owned) by each player.

As the player information 146, the following items are provided in association with each player ID:

(A1) a nickname;

(A2) a game start time;

(A3) a time (referred to hereafter as an “access time” or a “login time”) at which the game was most recently accessed (i.e. when the user most recently logged into the game), including when the player is still logged in;

(A4) a game level;

(A5) player IDs of other players with whom relationships such as friendships, follower relationships, and following relationships exist, and numbers of these players;

(A6) information relating to the specific player characters (for example, names, types (character types), information relating to abilities and information relating to owned items);

(A7) adjusted values to be used when the specific player characters are set as execution characters, and so on.

Further, as illustrated in FIG. 3B, the history information includes the following information in association with each player ID:

(B1) the login time to the game;

(B2) a total game playing time;

(B3) a type and a time of a game event that was participated in;

(B4) the number of times another player was contacted during the game, and the time of each contact;

(B5) the content of a message (including a standard message such as “Good job!”) sent to another player and the number of sent messages;

(B6) the content of a message received from another player and the number of received messages; and

(B7) the number of times a player character of another player is used.

The processing section 100 performs various types of processing using a main storage section 142 included in the storage section 140 as a work area. A function of the processing section 100 can be realized by hardware such as various types of processors (a CPU, a DSP, or the like) or an ASIC (a gate array or the like), or a program.

The processing section 100 performs various types of processing according to this embodiment on the basis of the program (data) stored in the information storage medium 180. In other words, a program that causes a computer to function as the respective sections of this embodiment (a program that causes a computer to execute the processing implemented by the respective sections) is stored in the information storage medium 180.

For example, the processing section 100 (a processor) performs various types of processing for controlling the entire server device 10, controlling the transfer of data and so on between sections, and the like on the basis of the program stored in the information storage medium. The processing section 100 also performs processing for providing various services in response to requests from the terminal device 20.

More specifically, the processing section 100 includes at least a communication control section 101, a web processing section 102, and a game management section 104.

The communication control section 101 performs processing for exchanging data with the terminal device 20 through a network. More specifically, the server device 10 performs various types of processing on the basis of information received by the communication control section 101 from the terminal device 20 and the like.

More particularly, the communication control section 101 performs processing for transmitting a game screen to the terminal device 20 of the user on the basis of a request from the terminal device 20 of the user.

The web processing section 102 functions as a web server. For example, the web processing section 102 performs processing for transmitting data in response to a request from the web browser installed in the terminal device 20 by means of a communication protocol such as Hypertext Transfer Protocol (HTTP), and performs processing for receiving data transmitted by the web browser installed in the terminal device 20.

Note that in this embodiment, an example of a case in which the server device 10 also functions as an SNS server will be described, but the server device 10 may be formed from a game server and an SNS server that are provided separately. Moreover, the game processing according to this embodiment may be implemented partially or entirely by the server device 10, and partially by the terminal device 20.

The game management section 104 executes game processing relating to a role-playing game (RPG) or a battle game played by each player in conjunction with the terminal device 20 on the basis of operations input by the player via the terminal device 20, and manages the player information, which includes a progress status of the game played by each user and item management information such as a character and various items used by each user.

Meanwhile, the game management section 104 stores and manages the game history of each player in the player information 146 as the game history information, and provides the respective terminal devices 20 with the game history information in response to a request from the terminal device 20 or the like.

For example, the game management section 104 manages the following items in association with the player ID of each player as the game history information of each player:

(A1) the login time (the access time) to the game and the total game playing time of each player;

(A2) information generated when a player character is used by another player (for example, the time, the type of the player character, and identification information (a player ID) indicating the player who used the player character);

(A3) an event ID of an event that was participated in during the game;

(A4) a type of opponent character, the player ID of the other player to whom the opponent character belongs, and the time of the battle;

(A5) the player ID of another player who executes a cooperative play and the time of the cooperative play;

(A6) a progress status such as a game level;

(A7) when a player character of another player is used, the player ID of the other player, the time at which the player character was used, and player character information including the type and abilities of the player character; and

(A8) the transmission/reception time and content of messages sent to another player or received from another player during the game, including standard messages such as “Good job!”.

Further, the game management section 104, in conjunction with the respective terminal devices 20, stores and manages the relationships of each player with other players, such as friendships, follower relationships, and following relationships, as well as the number of other players with whom each player has these relationships, in the player information 146 as relationship information, and provides the respective terminal devices 20 with the relationship information in response to a request from the terminal device 20 or the like.

For example, the game management section 104 manages the following items in association with the player ID of each player as the relationship information:

(B1) relationship types, namely friendships, follower relationships, and following relationships;

(B2) the player IDs of the other players with whom relationships of the respective types exist and the periods following establishment of the relationships with the other players;

(B3) the number of other players with whom relationships of the respective types exist.

### 3. Terminal Device

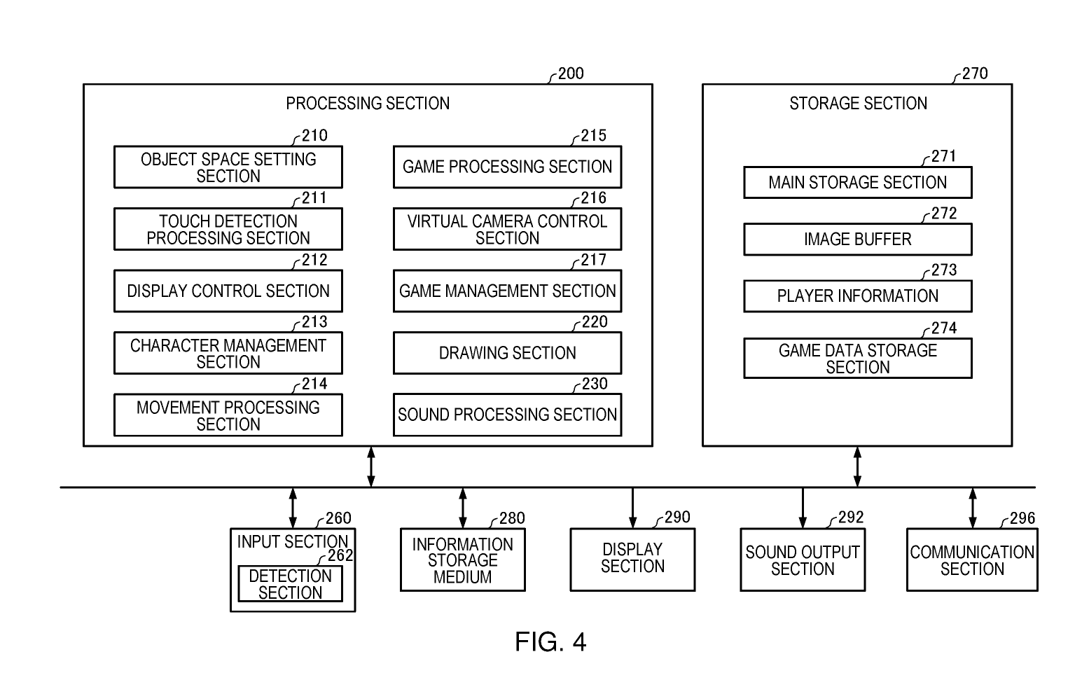

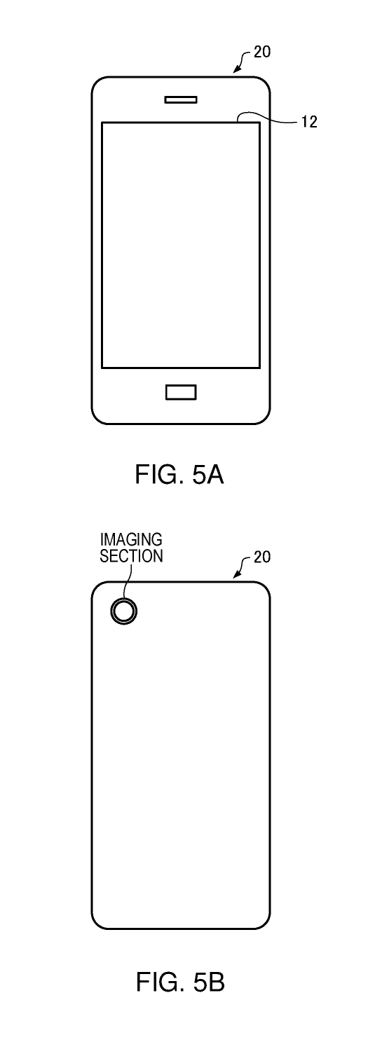

Next, the terminal device 20 according to one embodiment of the invention will be described using FIG. 4 and FIGS. 5A and 5B. Note that FIG. 4 is a functional block diagram illustrating an example of the configuration of the terminal device 20, while FIGS. 5A and 5B illustrate examples of the outer appearance of the terminal device 20. Also note that the terminal device 20 may have a configuration in which some of the constituent elements (sections) FIGS. 5A and 5B are omitted.

An input section 260 allows the player to input operation data, and a function of the input section 260 may be realized using a touch panel, a touch panel display, or the like. More specifically, the input section 260 includes a detection section 262 capable of detecting two-dimensional instruction position coordinates (x, y) on a screen on which an image is displayed. For example, the input section 260 includes a detection section 262 capable of detecting two-dimensional contact position coordinates (x, y) in a contact detection area (a touch panel).

In this embodiment, the contact position is position information obtained from the contact detection area when the player performs a contact operation (including direct contact and indirect contact using a pointing device).

Note that according to this embodiment, the contact operation performed by the player includes not only direct touch operations or sliding operations executed on a touch panel 12 by the user using a finger and touch operations or sliding operations executed on the touch panel 12 indirectly via a device such as a pointing device, but also pseudo-touch or pseudo-sliding operations executed on the touch panel 12 without performing direct or indirect touch or sliding operations on the touch panel 12.

For example, pseudo-touch or pseudo-sliding operations include touch operations or sliding operations that are recognized by detecting either actual contact with the touch panel 12 or an approach towards the touch panel 12, such as:

(1) a touch operation or sliding operation in which a plurality of emission sections, which emit light beams such as infrared beams in positions parallel to the touch panel surface and close to the touch panel surface and are formed at fixed intervals in vertical and horizontal directions on one end of the touch panel 12, and a plurality of sensors, which respectively form pairs with the emission sections and are provided on the other end of the touch panel opposite the emission sections in order to receive the light beams emitted respectively thereby, detect vertical and horizontal coordinates at which the light beams are blocked when the touch panel 12 is contacted or approached, and recognize the touch operation or sliding operation on the basis of the detected coordinates; and

(2) a touch operation or sliding operation in which a camera is provided to photograph the display surface of the touch panel 12, the camera detects the position coordinates in which the user contacts or approaches the touch panel 12, and the touch operation or sliding operation is recognized on the basis of the detected position coordinates.

In this embodiment in particular, the display screen (display) 12 in FIG. 5A is a touch panel display formed by laminating a liquid crystal display and a touch panel for detecting the contact position of the player (operator or user). In other words, in this embodiment, the display screen 12 functions as both the input section 260 and the display section 290.

Note that an operation to contact the display screen (referred to hereafter as a “touch panel” except in special cases) 12 may be performed using either a fingertip or an input device such as a touch pen.

Further, the input section 260 may include buttons and levers, a keyboard, a steering wheel, a microphone, an acceleration sensor, and so on into which operation information (operation signals) relating to items other than an instruction position can be input.

A storage section 270 serves as a work area for the processing section 200, a communication section 296, and so on, and a function thereof may be realized by a RAM (a VRAM) or the like. The storage section 270 includes a main storage section 271 that is used as a work area, an image buffer 272 that stores a final display image and so on, player information 273 representing information relating to the player who plays the provided game, and a game data storage section 274 that stores various types of data, such as table data, required to execute the game.

Note that some of these sections may be omitted or realized by the storage section 140 of the server device 10. Further, the storage section 270 may serve as storage means either alone or together with the storage section 140 of the server device 10, for example.

The player information 273 includes information (referred to as “player character information” hereafter) relating to the player characters managed (owned) by each player, relationship information indicating the relationships of each player with other players, and history information relating to the past game history of each player.

The player character information includes the types and abilities of the player characters, the number of times each player character has been set in the deck (a game field set as a plurality of player characters that can be used to execute the game) and the time thereof; and information (flag information, for example) indicating a specific player character that can be used by another player.

The relationship information includes information relating to each relationship, namely, for example, a follower relationship in which another player is followed, a following relationship in which a reference player (in other words, a home player) is followed, and a friendship in which mutual following and follower relationships exist.

The history information includes various information such as the login time (access time) at which the player logged into the game, the total game playing time, the content of messages (including standard messages such as “Good job!”) sent to another player and the number of sent messages, the content of messages received from another player and the number of received messages, and the number of times a player character of another player has been used.

Various types of information required to execute the game, condition information used during various types of determination processing, and so on are stored in the game data storage section 274.

An information storage medium 280 (a computer-readable medium) stores a program, data, and so on, and a function thereof may be realized by an optical disk (a CD or a DVD), a magneto-optical disk (an MO), a magnetic disk, a hard disk, magnetic tape, a memory (a ROM), or the like.

Further, a program that causes a computer to function as the respective sections of this embodiment (a program that causes a computer to execute the processing of the respective sections) may be stored in the information storage medium 280. As will be described below, the processing section 200 performs various types of processing according to this embodiment on the basis of the program (data) stored in the information storage medium 280.

The display section 290 outputs an image generated in accordance with this embodiment, and a function thereof can be realized by a CRT, an LCD, a touch panel display, a head-mounted display (HMD), or the like.

In this embodiment in particular, the display section 290 also functions as the input section 260 on which the player performs game operations using the touch panel display. Here, a resistive (4-wire or 5-wire) touch panel, a capacitive touch panel, an electromagnetic induction touch panel, an ultrasonic surface acoustic wave touch panel, an infrared scan touch panel, or the like, for example, may be used as the touch panel.

A sound output section 292 outputs a sound generated in accordance with this embodiment, and a function thereof can be realized by a speaker, headphones, or the like.

The communication section 296 performs various types of control for communicating with the outside (for example, a host device or another terminal device), and a function thereof can be realized by hardware such as various types of processors or a communication ASIC, a program, or the like.

Note that the terminal device 20 may receive a program and data that are stored in the information storage medium of the server device 10 or the storage section 270 in order to cause a computer to function as the respective sections of this embodiment through a network, and store the received program and data in the information storage medium 280 or the storage section 270. A case in which the terminal device 20 receives a program and data in order to function may also be included within the scope of the invention.

The processing section 200 (processor) executes processing such as game processing, image generation processing, and sound generation processing either in accordance with a program provided by the server device 10 or in conjunction with the server device 10 on the basis of input data from the input section 260, a program, or the like.

In this embodiment in particular, the game processing includes processing for starting the game when a game start condition is satisfied, processing for advancing various games, such as a battle game or a sport game, processing for placing various objects used in the game, such as a player object or an enemy object, processing for displaying the various objects, processing for calculating a game result, processing for terminating the game when a game termination condition is satisfied, and so on.

Further, the processing section 200 performs various types of processing using the storage section 270 as a work area. A function of the processing section 200 can be realized by hardware such as various types of processors (a CPU, a DSP, or the like) or an ASIC (a gate array or the like), or a program.

More specifically, the processing section 200 includes an object space setting section 210, a touch detection processing section 211, a display control section 212, a character management section 213, a movement processing section 214, a game processing section 215, a virtual camera control section 216, a game management section 217, a drawing section 220, and a sound processing section 230. The processing section 200 may have a configuration in which some of these sections are omitted.

Note, for example, that the display control section 212 serves as display control means, and the character management section 213 serves as selection means. Further, for example, the game processing section 215 serves as game control means, and the game management section 217 serves as management means, setting means, specifying means, and registering/updating means.

The object space setting section 210 performs processing for placing, or in other words setting, various objects (objects constituted by a primitive surface such as a sprite, a billboard, a polygon, a free-form surface, or a subdivision surface) representing display items such as an object (a player object, a moving object, or an enemy object), a movement path, a building, a tree, a pillar, a wall, or a map (a geographical feature) in an object space (in other words, a game space).

Specifically, the object space setting section 210 determines a position and a rotation angle (synonymous with an orientation and a direction) of an object (a model object), and places the object in the determined position ((X, Y) or (X, Y, Z)) and at the determined rotation angle (rotation angles about X and Y axes or rotation angles about X, Y, and Z axes).

More specifically, the object space setting section 210 defines a game space (in other words, a field) in which a player object or the like moves through the game, and sets restricting objects (also referred to as wall objects) that form walls for restricting the movement of the player object in given positions within the game space, which is displayed inside outermost edge portions of a displayable area of the touch panel 12 (the screen).

Note that the object space includes both a so-called virtual two-dimensional space and a so-called virtual three-dimensional space. A two-dimensional space is a space in which an object is placed at two-dimensional coordinates (X, Y), for example, and a three-dimensional space is a space in which an object is placed at three-dimensional coordinates (X, Y, Z), for example.

When the object space is a two-dimensional space, a plurality of objects are placed on the basis of a priority level set for each object. For example, processing may be performed to place the objects in order such that an object (a sprite) that is to appear on a far side is placed first, whereupon objects that are to appear on a near side are placed sequentially so as to overlap the placed object.

Further, by placing an object having a large drawing size on a lower side of an image, and placing an object having a small drawing size on an upper side of the image, an object space corresponding to the upper side of the screen can be made to appear to be on the far side, and an object space corresponding to the lower side of the screen can be made to appear to be on the near side.

Furthermore, when the object space is a three-dimensional space, the objects are placed on a world coordinate system.

The touch detection processing section 211 performs recognition processing for recognizing the input information input by the player using the input section 260. More specifically, the touch detection processing section 211 obtains an instruction position input using the input section 260.

For example, the touch detection processing section 211 obtains a contact position (two-dimensional contact position coordinates) within the contact detection area (the touch panel) in which a contact operation (in other words, a touch operation) performed by the user is detected as the instruction position.

In other words, the touch detection processing section 211 obtains a contact position (a detection position) during a contact operation period (a sliding operation period) corresponding to a period in which the player performs an operation (referred to hereafter as a “sliding operation”) to touch the touch panel 12 with a finger (referred to hereafter as “inputting a touch operation”), move the finger over the touch panel 12 while touching the touch panel 12, and finally remove the finger from the touch panel 12.

More particularly, the touch detection processing section 211 executes:

(1) first detection processing for detecting a first variation (referred to hereafter as a “condition variation”) from a condition (referred to hereafter as a “non-contact condition”) in which a touch operation has not been input onto the screen to a condition (referred to hereafter as a “contact condition”) in which a touch operation is input, and detecting a detection position (also referred to hereafter as a “first detection position”) in which the condition variation was executed;

(2) second detection processing for detecting variation in an input sliding operation (in other words, variation in the detection position) as a second variation when, after the first variation is detected, a sliding operation is input (referred to hereafter as “inputting a sliding operation”) while continuing the touch operation (in other words, continuing the contact condition) input at the time of detection of the first variation (in other words, variation from the non-contact condition to the contact condition), and detecting a detection position (also referred to hereafter as a “second detection position”) in which the condition variation was executed; and

(3) third detection processing for detecting a condition in which a touch operation is not input onto the screen during input of a sliding operation (in other words, a case in which input of the sliding operation is terminated such that the non-contact condition is re-established).

Further, the touch detection processing section 211 obtains the instruction position input at intervals of a predetermined period. More specifically, the predetermined period may be set at a frame interval of approximately 1/60 to 1/120 of a second, for example.

The display control section 212 displays images relating to the game, including operation input objects visualizing player instructions, on the touch panel 12.

The character management section 213 selects a player character to be set in the deck from the plurality of player characters stored in the player information 273 and managed (owned) by each player as an execution character on the basis of an instruction from the player.

The character management section 213 then registers the player character selected as the execution character in the player information 273 as deck data.

The movement processing section 214 performs movement calculations with respect to the objects in the object space (in particular, operation subject objects controlled as moving body objects that move through the game space, such as character objects corresponding to the execution characters set in the deck and items thereof).

In other words, the movement processing section 214 performs processing for moving the moving body object within the object space or controlling an operation (motion or animation) of the moving body object on the basis of the data input by the player using the input section 260, a program (a movement algorithm), various data (motion data), and so on.

More specifically, the movement processing section 214 performs simulation processing for determining movement information (a movement direction, a movement amount, a movement speed, a position, a rotation angle, or an acceleration) and operation information (the position or rotation angle of each partial object) in relation to the object sequentially for each frame. Here, a frame is a unit of time used when implementing movement processing and operation processing (simulation processing) on an object, and image generation processing. In this embodiment, a frame rate may be fixed or varied in accordance with a processing load.

Note that the movement processing section 214 may also perform processing for moving the object in a three-dimensional object space on the basis of an input direction (a sliding direction, for example). For example, a movement direction is associated with each input direction in advance, and the object is moved in the movement direction that corresponds to the input direction.

The game processing section 215 executes various types of game calculation processing. For example, when a plurality of player characters to be used during the game are set in the deck on the basis of an instruction issued by the player, the game processing section 215 executes processing for advancing the game using each of the player characters set in the deck.

More particularly, the game processing section 215 performs calculation processing required to execute the game, such as forming an object space based on a map, causing the player object (the execution character) to battle an enemy character, and calculating parameters of each character during the battle.

Note that the game processing section 215 executes the calculation processing in conjunction with the server device 10, but may be formed partially or entirely in the server device 10 instead.

The virtual camera control section 216 generates an image that is viewed from a given viewpoint so as to appear to have depth. In this case, the virtual camera control section 216 performs processing for controlling a virtual camera (a viewpoint) used to generate an image that is viewed from a given (an arbitrary) viewpoint within the object space. More specifically, the virtual camera control section 216 performs processing for controlling a position (X, Y, Z) or a rotation angle (rotational angles about the X, Y, and Z axes) of the virtual camera (processing for controlling the viewpoint position or the sightline direction).

For example, when an object (a character, a ball, or a car, for example) is photographed from behind using the virtual camera, the virtual camera control section 216 controls the position or the rotation angle of the virtual camera (the orientation of the virtual camera) so that the virtual camera follows variation in the position or rotation of the object.

In this case, the virtual camera control section 216 can control the virtual camera on the basis of information about the position, rotation angle, speed, and so on of the object, which is obtained by the movement processing section 214. Alternatively, the virtual camera control section 216 may perform control for rotating the virtual camera by a predetermined rotation angle or moving the virtual camera along a predetermined movement path. In this case, the virtual camera control section 216 controls the virtual camera on the basis of virtual camera data for specifying the position (the movement path) or the rotation angle of the virtual camera.

Note that when a plurality of virtual cameras (viewpoints) exist, the control processing described above is executed on each virtual camera.

The game management section 217 manages parameters of the player characters set in the deck, and manages relationships with other players, including registering and updating the relationship information.

The drawing section 220 performs drawing processing on the basis of the results of the various types of processing (game processing) performed by the processing section 200 in order to generate an image, and outputs the generated image to the display section (display) 290. The image generated by the drawing section 220 may be a so-called two-dimensional image or a so-called three-dimensional image. More specifically, the drawing section 220 generates an image that is viewed from the virtual camera within the object space and is displayed on a screen.

Here, when the drawing section 220 generates two-dimensional images, the drawing section 220 draws the objects in order from the object with the lowest set priority, and in a case where objects overlap, draws an object with a higher priority over an object that has already been drawn.

Further, when the drawing section 220 generates three-dimensional images, first, the drawing section 220 receives input object data (model data) including vertex data (position coordinates, texture coordinates, color data, a normal vector, an α-value, and so on of a vertex) representing each vertex of the object (model), and then the drawing section 220 performs vertex processing on the basis of the vertex data included in the input object data. Note that the drawing section 220 may, if necessary, perform vertex generation processing (tessellation, curved surface division, or polygon division) for subdividing a polygon when performing the vertex processing.

Further, during the vertex processing, the drawing section 220 performs vertex movement processing and geometric processing such as coordinate transformation (world coordinate transformation or camera coordinate transformation), clipping processing, perspective transformation, or light source processing, and modifies (updates or adjusts) the vertex data given for each of the vertices forming the object on the basis of the processing results. The drawing section 220 then performs rasterization (scan conversion) on the basis of the vertex data subjected to the vertex processing in order to associate a surface of the polygon (the primitive) with pixels. Following rasterization, the drawing section 220 performs pixel processing (fragmenting processing) for drawing the pixels that form the image (fragments that form the display screen).

During the pixel processing, the drawing section 220 determines a final drawing color of each of the pixels forming the image by performing various types of processing such as texture reading (texture mapping), color data setting/modification, translucent blending, and anti-aliasing, and then outputs (draws) the drawing color of the object subjected to perspective transformation to the image buffer 272 (a frame buffer or a buffer capable of storing image information in pixel units; a VRAM or a rendering target). In other words, during the pixel processing, per-pixel processing is implemented to set or modify the image information (the color, the normal, the luminance, the α-value, and so on) in pixel units.

The drawing section 220 thus generates an image that is viewed from the virtual camera (a given viewpoint) set within the object space. Note that when a plurality of virtual cameras (viewpoints) exist, an image may be generated such that images viewed from the respective virtual cameras can be displayed within one screen as divided images.

Note that the vertex processing and pixel processing performed by the drawing section 220 may be realized by hardware known as a so-called programmable shader (a vertex shader or a pixel shader) that enables programmable polygon (primitive) drawing processing by means of a shader program written in a shading language. The programmable shader enables programmable per-vertex unit processing and per-pixel processing, thereby increasing a degree of freedom with respect to the content of the drawing processing and significantly improving representation capability in comparison with fixed hardware drawing processing.

When drawing an object, the drawing section 220 performs geometric processing, texture mapping, hidden surface removal processing, α-blending processing, and so on.

During the geometric processing, the object is subjected to processing such as coordinate transformation, clipping processing, perspective projection transformation, or light source calculation. The drawing section 220 then stores the object data (the vertex position coordinates, texture coordinates, color data (luminance data), normal vector, α-value, or the like of the object) subjected to the geometric processing (subjected to perspective projection transformation) in the storage section 270.

During the texture mapping, processing is performed to map a texture (a texel value) stored in a texture storage section of the storage section 270 onto the object. Specifically, the drawing section 220 reads a texture (surface properties such as color (RGB) and α-value) from the texture storage section of the storage section 270 using the texture coordinates set in (assigned to) each vertex of the object and so on, and maps the texture, which is a two-dimensional image, onto the object. In this case, the drawing section 220 performs pixel-texel association processing, bilinear interpolation as texel interpolation, and so on.

Note that in this embodiment, processing for mapping a given texture may be performed when drawing the object. In this case, a color distribution (a texel pattern) of the texture to be mapped can be varied dynamically.

Further, in this case, a texture having a different color distribution (pixel pattern) may be generated dynamically, or a plurality of textures that differ in color distribution may be prepared in advance and selected for use dynamically. Furthermore, the color distribution of the texture may be varied in object units.

During the hidden surface removal processing, hidden surface removal processing is performed using a Z-buffer method (a depth comparison method or a Z-test) that utilizes a Z-buffer (a depth buffer) storing a Z-value (depth information) of a drawing subject pixel. More specifically, the drawing section 220 refers to the Z-value stored in the Z-buffer when drawing the drawing subject pixel that corresponds to the primitive of the object, and compares the Z-value stored in the Z-buffer with the Z-value of the drawing subject pixel of the primitive. When the Z-value of the drawing subject pixel is a Z-value (a small Z-value, for example) indicating a position on the near side when viewed from the virtual camera, the drawing section 220 implements processing to draw the drawing subject pixel, and updates the Z-value stored in the Z-buffer with a new Z value.

During α-blending, the drawing section 220 performs translucent blending processing (noinial α-blending, additive α-blending, subtractive α-blending, or the like) based on the α-value (the A-value). Note that the α-value is information that can be stored in association with each pixel (texel or dot), for example additional information other than the color information. The α-value can be used as mask information, translucency (equivalent to transparency or opacity), bump information, and so on.

In particular, the drawing section 220 may generate an image to be displayed in a display area corresponding to the contact detection area. The image displayed in the display area may be an image including an object, for example.

The sound processing section 230 performs sound processing on the basis of the results of the various types of processing performed by the processing section 200 in order to generate game sound such as BGM, effect sounds, or voices, and outputs the generated game sound to the sound output section 292.

Note that the terminal device 20 may implement a system having only a single player mode that allows only one player to play, or may implement a system that also includes a multiplayer mode that allows a plurality of players to play.

Further, when a plurality of players play, the game images and game sound provided to the plurality of players may be generated using a single terminal device 20, or may be generated by distributed processing using a plurality of terminal devices 20 or the server device 10, which are connected by a network (a transmission line or a communication line) or the like.

### 4. Method

### 4.1 Outline

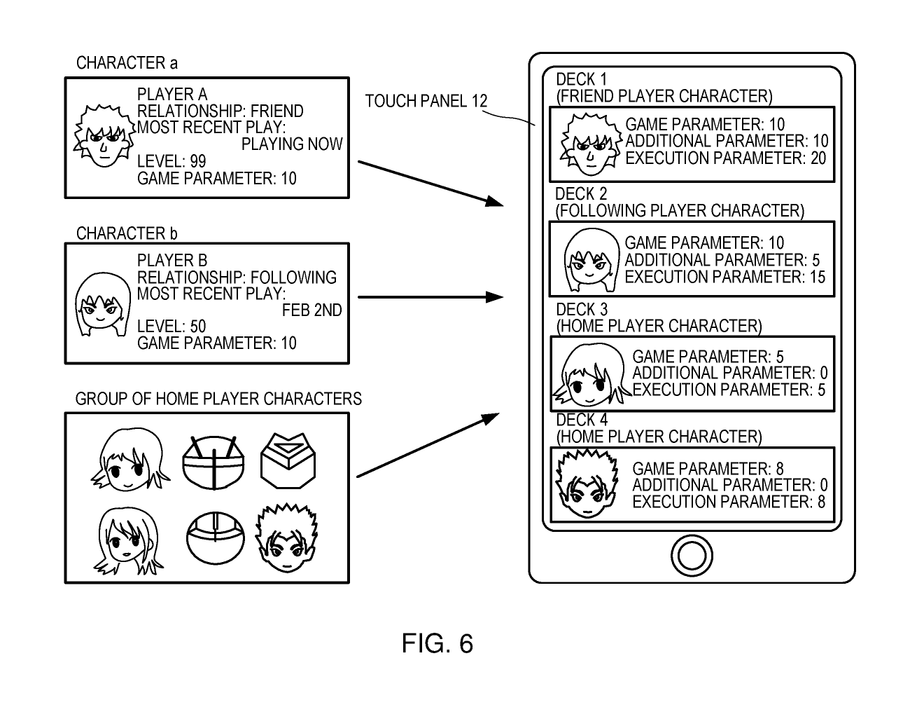

Next, a method (adjusting an execution parameter during processing for setting an execution character) according to one embodiment of the invention will be described using FIG. 6. Note that FIG. 6 illustrates adjustment of an execution parameter during processing for setting an execution character according to this embodiment.

The terminal device 20 according to this embodiment is configured to set a plurality of player characters in a deck, and execute a game such as a battle game, a shooting game, or an RPG using the player characters (in other words, execution characters) set in the deck.

More particularly, the terminal device 20 is configured to be capable of selecting a plurality of player characters as execution characters from among player characters (referred to hereafter as “home player characters”) owned by the terminal device 20 itself and player characters (referred to hereafter as “other-player player characters”) owned by other players, and set the selected player characters in a deck.

Further, when an other-player player character is set as an execution character, the terminal device 20 sets a parameter of the other-player player character serving as the execution character (referred to hereafter as a “specific player character”) on the basis of a relationship between the player and the other player managing the specific player character.

More specifically, the terminal device 20 is configured to:

(1) execute selection processing to select, on the basis of an instruction from the player, a player character to be used in the game as an execution character from among a plurality of player characters that can be used by the player, the plurality of player characters including, as a specific player character, player characters that are managed by other players;

(2) execute setting processing for setting a game parameter value stored in the player information 246 of each selected execution character and the server device 10 at a given game parameter value for executing the game, and using the set game parameter value as an execution parameter value; and

(3) execute the game on the basis of the set plurality of execution characters and the set execution parameter values thereof.

When a specific player character is selected as an execution character in the setting processing, the terminal device 20 adjusts the execution parameter on the basis of the relationship information indicating the relationship between the player who issued a selection instruction during the selection processing (i.e. the home player) and the other player managing the specific player character.

For example, a case in which, among four player characters that can be set in the deck, two specific player characters, namely a player character (referred to hereafter as a “friend player character”) a of a player A who has a friendship with the home player and a player character (referred to hereafter as a “followed player character”) b of a player B who has a following relationship with (i.e. is followed by) the home player are set in the deck as execution characters (in other words, ghost characters) and the remaining execution characters are player characters of the home player (in other words, home player characters) is envisaged.

In this case, as illustrated in FIG. 6, the terminal device 20 adjusts a parameter value denoting a game parameter (the number of points required to execute a gacha, for example) of each of the player characters set in the deck such that with respect to the friend player character, the parameter value is adjusted to a value obtained by adding a predetermined value (10 points, for example) to a value (10 points) allotted specifically to a specific player character, and with respect to the followed player character, the parameter value is adjusted to a value obtained by adding a predetermined value (5 points, for example, i.e. a smaller value than that of a friend) to the value (10 points) allotted specifically to a specific player character.

In this embodiment, according to the above configuration, when the game is executed and a player character of another player is used as a ghost character, for example, an execution parameter value that is advantageous in terms of advancing the game can be set on the basis of the relationship to the other player within the game (for example, a follower relationship, a following relationship, or a friendship), and as a result, an advantageous effect can be acquired during the game.

In this embodiment, therefore, relationships must be built with other players in the game in order to acquire an advantageous effect during the game, and as a result, communication with other players can be actively promoted.

Hence, in this embodiment, the number of participants in a game can be increased and the game can be enlivened, and interest in the game can be increased by incorporating relationship building with other players as a game element.

Note that in this embodiment, a predetermined number (1, for example) of player characters that can be used by another player are registered in the server device 10 in advance, this player character having been selected by selection processing from among the plurality of player characters managed by the home player in response to an instruction from each player.

### 4.2 Battle Game

Next, a battle game executed according to one embodiment of the invention will be described.

The terminal device 20 executes a battle game (a turn-based battle game) in which a plurality of player characters set in the deck in advance by the player and a plurality of enemy characters set in the deck by a computer or another player, for example, execute attacks in sequence.

In particular, the game management section 217 sets the player characters (including items with which the player characters are equipped) to be used in the battle game in the deck on the basis of operations input by the player, and sets the game parameter defined for each player character as a game parameter for executing the game.

The game processing section 215 then executes the battle game on the basis of the set player characters and the respective game parameters thereof.

In particular, the game processing section 215 executes game processing in relation to each player character for moving the player character as a moving body object in an opposite direction to a sliding direction of a sliding operation input by the player and with an energy corresponding to the sliding amount of the input sliding operation, and attacking an enemy character disposed in the game space in accordance with the set game parameter value.

In other words, the game processing section 215 specifies one player character by switching the player character that is to execute an attack in accordance with a given execution sequence, and executes game processing including movement control that is executed on the specified player character within the game space in accordance with the input sliding operation, and attacking an enemy character.

For example, the game processing section 215 executes the game processing including movement control that is executed on the player character within the game space and attacking an enemy character in conjunction with the movement processing section 214.

When a change to a condition (contact release) in which a touch operation is no longer input onto the screen is detected during input of the sliding operation, the movement processing section 214 controls the movement of the player character through the game space and the processing (attacking an enemy character, for example) that accompanies the movement in accordance with the game parameter so as to correspond to the sliding direction, sliding amount, and sliding time of the input sliding operation, or a combination of two or more thereof.

In particular, when a wall object exists in the movement direction and the player character contacts the wall object, the movement processing section 214 executes movement control to cause the player character to rebound from the contacted wall object by an amount corresponding to the remaining energy for moving the player character, which is determined on the basis of the sliding amount, until the energy is exhausted.

When the game processing section 215 detects contact with an enemy character during the movement control, the game processing section 215 executes attack processing such as attacking the enemy character on the basis of an attacking power, which varies according to the movement control, and the set game parameter value.

Note that the game processing section 215 executes the attack processing on the basis of both the attacking power that varies according to the movement control, and the set game parameter value, but may execute the attack processing only on the basis of the attacking power that varies according to the movement control.

Furthermore, in the above description, a game in which player characters are used as moving body objects was described, but when an item (a bullet, for example) such as a missile used by the player character is used as the moving body object, for example, the game processing section 215 specifies one player character by switching the player character serving as the object related to the operation subject with which an attack is to be executed in accordance with a given execution sequence, and executes game processing including movement control that is executed within the game space on an item of the specified player character and attacking an enemy character.

### 4.3 Relationship Information and Game Parameter

Next, the relationship information and the game parameter according to one embodiment of the invention will be described.

The relationship information is information indicating a relationship between a player and another player within the game. For example, the relationship information indicates following relationships, follower relationships, and friendships.

More specifically, a following relationship is a relationship in which a player can view another player or predetermined information and statuses of the other player relating to the game as a function of the game, a follower relationship is a relationship in which another player is allowed to view the home player or predetermined information and statuses of the home player relating to the game as a function of the game, and a friendship is a relationship in which mutual following and follower relationships exist.

In other words, the relationship information includes information indicating a follower condition denoting follower relationships, a following condition denoting following relationships, and a friend condition denoting friendships, and also includes an unrelated condition denoting the absence of any of the above relationships.

Further, the relationship information is stored in the storage section 140 of the server device 10 and the storage sections 270 of the respective terminal devices 20 as required for each player in association with each of the other players (more specifically, in association with the player IDs of the other players), and in addition to the type information indicating the type of relationship, i.e. friendship, follower relationship, or following relationship, as described above, includes information (referred to hereafter as “time information”) indicating the time at which the relationship was established as supplementary information.

Note that instead of the time information, information (referred to hereafter as “period information”) denoting periods from establishment of the relationships of the respective types to the present may be stored in the relationship information according to this embodiment as the supplementary information. In this case, the game management section 217 calculates and updates the periods from establishment of the relationships of the respective types to the present at a predetermined timing such as 24:00 each day.

The relationship information according to this embodiment is used as information for determining the value of the game parameter set when a player character of another player is set in the deck as a player character of the home player.

In other words, the relationship information according to this embodiment is used as information for setting a value of a game parameter that is advantageous in terms of advancing a game such as a battle game in accordance with the relationship information as the value of an execution parameter when a player character of another player (i.e. a specific player character) is selected as a player character of the home player (i.e. an execution character) and set in the deck.

More specifically, the execution parameter according to this embodiment includes a game parameter relating to a specific player character set as an execution character, or a game parameter of a team formed from the player and the execution characters set in the deck.

Further, the game parameter, including the execution parameter, includes:

(1) the number of points used in the game, such as a score, in-game currency, a physical strength value, or an experience value, which is allocated to the team formed from the home player and the player characters set in the deck in order to execute the game, or allocated to each player character set as an execution character;

(2) an ability value (an attack ability, a defense ability, or a winning probability) of the team or an ability value employed when the specific player character executes the game; or

(3) a value obtained by adjusting (correcting) the value of (1) or (2) (by increasing or reducing the ability value by +10 points or +10%, for example).

Note that each player can set a specific player character that can be used by another player in advance, and information (a type, an initial game parameter value, and respective ability values) relating to the specific player character registered by each player is stored in the server device 10 (the storage section 140) as a part of the player information 146.

Further, in this embodiment, when the game parameter is set for each execution character and player characters managed by the home player are set in the deck, the game parameter values included in the information set in relation to the player characters in the player information 273 of the home player are set as is or used as is as the game parameter of the player or team.

### 4.4 Relationship Information Registration Processing (Including Deletion Processing and Display Control Processing)

Next, relationship information registration processing according to one embodiment of the invention will be described.

The game management section 217 creates a list of registration candidates on the basis of registration processing based on an ID search using the player IDs, registration processing based on a follower list, and a predetermined program, and registers a relationship with another player by executing registration processing on the basis of the list of registration candidates (referred to hereafter as a “candidate list”).

Further, when the game management section 217 detects a given instruction in a case where a specific player character managed by another player is displayed on the touch panel 12 together with the relationship information indicating the relationship between the player executing the registration processing (in other words, a specific player, i.e. the home player) and the other player, the game management section 217, in conjunction with the server device 10, executes control in relation to the player (i.e. the home player) to register, delete, or otherwise process the relationship with the other player managing the detection subject specific player character, and update the corresponding relationship information on the basis of the control result.

### <Registration Processing Based on ID Search>

The game management section 217 executes following registration processing to follow another player in response to a predetermined operation performed during the game. When the following registration processing is executed to follow another player, the game management section 217 executes follower registration processing in relation to the other player to register the player (i.e. the home player) executing the following registration processing as a follower.

As the following registration processing, the game management section 217, in conjunction with the server device 10, searches a player list (data indicating a list of players participating in the game) stored in the server device 10 on the basis of a player ID input therein upon reception of an operation performed by the player.

Then, when the input player ID matches the player ID on the list, the game management section 217 executes following registration processing to register the relationship of the player executing the search (i.e. the home player) with the other player having the input player ID (in other words, a subject player) as a following relationship (in other words, registers relationship information indicating a following relationship), and update the player information 146 of the server device and the player information 273 of the storage section 270.

At this time, the game management section 217 executes follower registration processing to register the relationship of the other player having the input player ID (i.e. the subject player) with the player executing the search (i.e. the home player) as a follower relationship (in other words, registers relationship information indicating a follower relationship), and update the player information 146 of the server device and the player information 273 of the storage section 270.

Further, when the relationship between the other player having the input player ID inputted by the home player executing the search and the home player has already been registered as a following relationship (when the other player is already a follower of the home player), based on the following registration processing, the game management section 217 executes friend registration processing to register the relationship with the other player as a friendship (in other words, relationship information indicating a friendship is registered), and updates the player information 146 of the server device and the player information 273 of the storage section 270.

### <Registration Processing Based on Follower List>

The game management section 217, in conjunction with the server device 10, executes friend registration processing by generating a follower list listing player IDs of other players following the home player on the basis of an instruction from the player or in accordance with the program during execution of the game, and executing following registration by having the player select a follower from the generated follower list.

More specifically, the game management section 217 extracts player IDs of players who follow the home player from the player information 146 of the server device and the player information 273 of the storage section 270, and generates the follower list by listing the group of extracted player IDs. Note that at this time, the game management section 217 generates the follower list by excluding other players with respect to whom relationship information indicating a friendship has already been registered.

Further, the game management section 217 may generate the follower list in a predetermined order such as random order or player ID order, and may also extract a predetermined number of registration candidates in chronological order of follower registration or in order of the most recent play times of the other players (including those still playing).

### <Registration Processing Based on Candidate List>

At a predetermined timing or on the basis of a player instruction, the game management section 217, in conjunction with the server device 10, extracts other players who satisfy a predetermined condition as following relationship or friendship registration candidates on the basis of the history information indicating the game history of the home player, and lists the extracted registration candidates together with information (player IDs, nicknames, game levels, most recent play times, and statuses) relating to the other players.

The game management section 217 then executes registration processing by executing following registration or friend registration by having the player select another player from the generated following relationship or friendship registration candidate list (referred to hereafter as a “registration candidate list”).

Note that in this case, the game management section 217 excludes other players already having relationship information indicating a following relationship or a friendship from the list.

For example, the game management section 217 generates the following relationship registration candidate list by extracting unrelated other players who set (or in other words, used) a player character as an execution character within a period (referred to hereafter as a “reference period”) extending from the present time to a predetermined point in the past (one week ago, for example) or unrelated other players who transmitted or received a message within the reference period.

Further, for example, the game management section 217 generates the following relationship registration candidate list by extracting unrelated other players who set a player character as an execution character a predetermined number of times (three or more times, for example) during a previous game or unrelated other players who transmitted or received a message a predetermined number of times (three or more times, for example) during a previous game.

Meanwhile, for example, the game management section 217 generates the friendship registration candidate list by extracting other players who have a follower relationship and who set a player character as an execution character within a period (referred to hereafter as a “reference period”) extending from the present time to a predetermined point in the past (one week ago, for example), or other players who have a follower relationship and who transmitted or received a message within the reference period.

Further, for example, the game management section 217 generates the friendship registration candidate list by extracting other players who have a follower relationship and who set a player character as an execution character a predetermined number of times (three or more times, for example) during a previous game, or other players who have a follower relationship and who transmitted or received a message a predetermined number of times (three or more times, for example) during a previous game.

Note that the game management section 217 may, for example, ask the home player whether or not to follow an unrelated other player used in an immediately preceding battle game, and register relationship information for setting the relationship with the other player as a following relationship on the basis of an instruction from the home player.

Further, when the length of the registration candidate list is limited due to display limitations on the game screen or the like, the game management section 217 extracts a predetermined number of registration candidates on the basis of a degree of priority of each of the other players serving as the registration candidates, the degree of priority being set to increase steadily as the time a player character was used or the time a message was transmitted becomes more recent, or as the number of uses increases, for example.

Further, when the game management section 217 displays the registration candidates on the touch panel 12 in conjunction with the display control section 212, the registration candidates are displayed in descending order of the degree of priority.

### <Friend Registration>

At a timing of an instruction to register a following relationship or a follower relationship, or at a predetermined timing such as 24:00 each day, the game management section 217, having determined that a player and another player have both a following relationship and a follower relationship, determines that the relationship between the players is a friendship.

Accordingly, the game management section 217 registers relationship information between the player and the other player determined to be friends as a friendship in the player information 146 of each of the players.

### <Automatic Relationship Registration>

Even in a case where neither a following relationship nor a follower relationship has yet been registered as a relationship between players, as long as a predetermined condition is satisfied, the game management section 217 may specify the players satisfying the condition as having a friendship, a following relationship, or a follower relationship, and may register the relationship information between the relevant players as a friendship, a following relationship, or a follower relationship in the player information 146 of each of the players.

More specifically, the game management section 217 is configured to:

(1) execute specification processing at a given timing on the basis of the game-related history information of each player, which is stored in the server device 10, to specify another player who satisfied a given condition during a previous game with the relevant player; and

(2) register the relationship of the relevant player with the specified other player in the server device 10 as relationship information on the basis of the satisfied given condition.

In this embodiment, examples of the given condition include:

(1) participating in the same event as the relevant player at least a predetermined number of times;

(2) contacting the other player during a game at least a predetermined number of times;

(3) transmitting a specific message (including a standard message such as “Good job!”) to the other player, or transmitting a message at least a predetermined number of times;

(4) receiving a specific message from the other player, or receiving a message at least a predetermined number of times;

(5) using a player character of the home player at least a predetermined number of times; and

(6) using a player character of the other player at least a predetermined number of times.

Furthermore, in this embodiment, for example, conditions (1) and (2) are used as determination conditions for determining a friendship, conditions (3) and (6) are used as follower relationship conditions, and conditions (4) and (5) are used as following relationship conditions.

Moreover, when relationship information indicating a following relationship is already registered and conditions (4) and (5) are established, or when relationship information indicating a follower relationship is already registered and conditions (3) and (6) are established, a friendship is determined to exist.

### <Display Control Processing During Registration Processing>

When executing following registration, follower registration, and friend registration, the game management section 217 cooperates with the display control section 212 while cooperating with the server device 10 to display information (the player ID, nickname, player level, and most recent play time or status) relating to the player characters managed by the other player and the game of the other player on the touch panel 12.

More particularly, as will be described below, during the registration processing described above, the display control section 212 displays, in association with a specific player character, relationship information between the other player who manages the specific player character and the player executing the registration processing, or information (to be referred to hereafter as “relationship-related information”) relating to the relationship statuses of the other player managing the specific player character with different players to the other player.

Note that the display control processing executed by the display control section 212 during the registration processing will be described in detail below.

### <Registration Deletion>

As described above, when the relationship information between the other player managing the specific player character and the player executing the registration processing or the relationship-related information of the other player managing the specific player character is displayed on the game screen in the form of a candidate list or the like and relationship information indicating a following relationship, a follower relationship, or a friendship has already been registered, the game management section 217 deletes the registered relationship on the basis of a detected given instruction such as a player instruction, and updates the player information 146 of the server device and the player information 273 of the storage section 270 accordingly.

Note that the “given instruction” may be an instruction issued by the player by performing an operation, or an instruction prescribed by the program and issued during the game processing, for example when a limit on a period for registering a relationship with another player is reached in a case where such a limit exists, or the like.

### <Others>

In this embodiment, the number of people who can be set in the following condition or the follower condition may be limited (to 10 people, for example), but does not have to be limited. Further, the upper limit of the number of people may be raised steadily as the game level increases.

### 4.5 Execution Character Selection Processing

Next, processing for selecting an execution character according to one embodiment of the invention will be described.

The character management section 213 executes selection processing on the basis of an instruction from the player to select a player character to be used in the game as an execution character from among a group of selectable player characters including the player characters managed by the home player and the specific player characters managed by the other players.

In particular, a predetermined number (1, for example) of player characters that can be used by other players when setting the deck are registered in advance in the server device 10 as specific player characters, and therefore the character management section 213 obtains information relating to the pre-registered specific player characters of the other players in conjunction with the server device 10, and displays the obtained specific player characters so as to be selectable as execution characters in conjunction with the display control section 212.

Further, in this embodiment, a minimum number (at least 1) of home player characters that must be selected and so on are determined in advance, and the character management section 213 executes the selection processing under these limitations.

Furthermore, when the character management section 213 displays a group of player characters that can be selected as execution characters in conjunction with the server device 10 and the display control section 212, the group of player characters may be displayed according to player character type, such as home player characters and specific player characters, according to the type of relationship with the other player, such as friendship and so on, or according to an adjustment value by which the execution parameter is adjusted. Alternatively, the other players who logged into the game most recently (for example, other players who logged in over the last two days) may be extracted, and the specific player characters managed by the extracted other players may be displayed preferentially.

Note that the display control section 212 that displays the group of player characters that can be selected as execution characters will be described in detail below.

### 4.6 Parameter Setting Processing

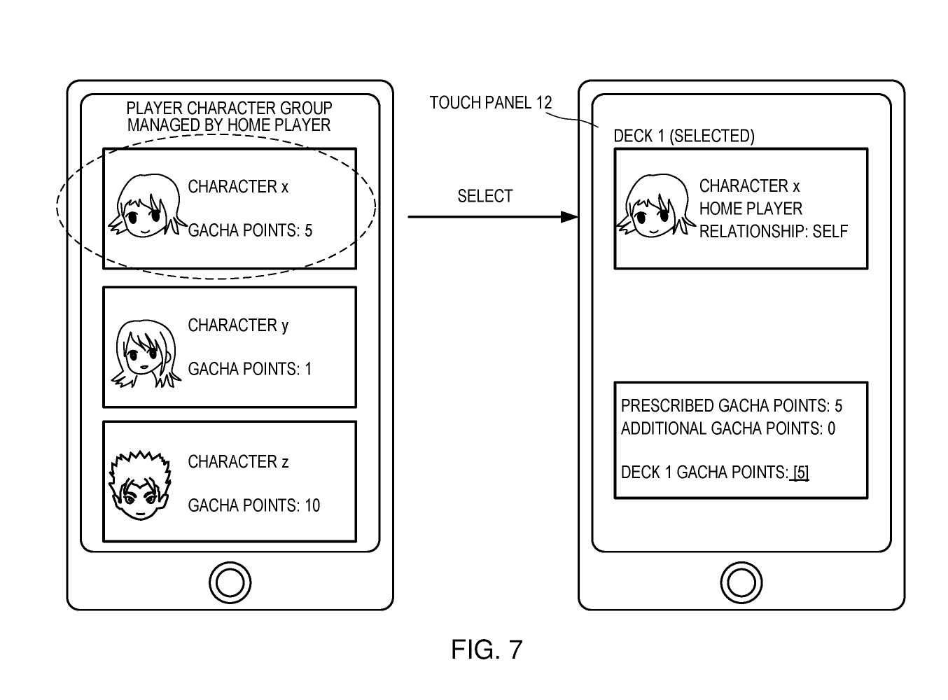

Next, using FIGS. 7 to 12, parameter setting processing according to one embodiment of the invention will be described. Note that FIGS. 7 to 12 illustrate the parameter setting processing according to this embodiment.

### <Basic Principles>

When the game management section 217 executes selection processing to select a predetermined number of player characters from the plurality of player characters that can be set by the player as execution characters with which to execute a game such as a battle game, and set the selected player characters in a deck, information (in particular, the game parameter values set in relation to the player characters) relating to the set player characters is obtained from the player information 273 and so on, and the obtained game parameter values are set as the game parameters used to execute the game.

In particular, as described above, the game management section 217 sets the game parameters relating respectively to the player characters (including specific player characters) set in the deck as the execution characters or the game parameter of the team formed from the player and the execution characters set in the deck as the parameters used to execute the game (in other words, the execution parameters).

At this time, when a player character managed by the home player is selected as an execution character, the game management section 217 sets the game parameter value of this player character, obtained from the player information 273, as is (i.e. without adjustment) as the execution game parameter.

When, on the other hand, a player character managed by another player (i.e. a specific player character) is selected as an execution character, the game management section 217, in conjunction with the server device 10, adjusts the game parameter value of the specific player character, which is stored in the server device 10 (more specifically, the player information 146 of the other player), on the basis of the relationship information indicating the relationship of the other player to the home player, and sets the adjusted game parameter value as the game parameter used to execute the game.

In other words, in this case, the game management section 217 adjusts the value of the game parameter of the specific player character set as the game parameter for executing the game on the basis of the friendship, follower relationship, and following relationship.

More specifically, when a player character managed by another player (i.e. a specific player character) is selected as an execution character, the game management section 217 adjusts the execution parameter to a value at which a steadily more advantageous effect is acquired in order of following relationship, follower relationship, and friendship.

In other words, the game management section 217 sets the value of an ability-related execution parameter of the specific player character selected as an execution character, such as attacking power, defensive power, agility, or magic power, at a steadily increasing value (i.e. increases the values thereof) in order of following relationship, follower relationship, and friendship.

For example, in order to acquire a large number of friendship registrations having more advantageous execution parameter values, communication between players must be executed actively, and communication between players is also required to acquire a large number of friendship registrations.

Hence, to ensure that communication between players is used as a game element, the game management section 217 varies the value of the execution parameter according to the relationship type indicated by the relationship information, and when the specific player character of another player having a relationship that requires more communication to build is selected as an execution character, the game management section 217 adjusts the execution parameter to a value at which a more advantageous effect can be acquired.

For example, when the home player and the other player have a following relationship (i.e. when the home player follows the other player), the game management section 217 increases a reference execution parameter value x by a multiple of 1.5, i.e. to a value of 1.5x, in order to increase the ability of the player managing the execution character.

Further, for example, when the relationship is a follower relationship (i.e. when the other player is a follower of the home player), the game management section 217 adjusts the reference execution parameter value x by a multiple of 2, i.e. to a value of 2x, in order to increase the ability of the execution character, and when the relationship is a friendship, the game management section 217 adjusts the reference execution parameter value x by a multiple of 3, i.e. to a value of 3x, in order to increase the ability of the execution character.

Furthermore, when a specific player character is selected as an execution character, the game management section 217 varies a characteristic relating to the ability of the execution character, which is determined according to the execution parameter, in accordance with the friendship, following relationship, and follower relationship.

In other words, the game management section 217 can modify an ability characteristic of the execution character, such as an attack characteristic or a defense characteristic of the specific player character selected as the execution character, according to the friendship, follower relationship, and following relationship, and as a result, a strategic element of communicating with other players can be introduced into the game, leading to increased interest in the game.

For example, when the home player and the other player have a following relationship (i.e. when the home player follows the other player), the game management section 217:

(A) modifies an ability characteristic by which the execution character executes a single attack during a single attack turn to an ability characteristic in which the attack frequency during a single attack turn is increased (for example, an ability characteristic in which a plurality of attacks (including consecutive attacks) are executed when attacks are executed by a plurality of player characters during the turn of the player characters); or

(B) modifies the ability characteristic to an ability characteristic in which the execution character is capable of consecutive attacks (for example, an ability characteristic in which a plurality of attacks are executed consecutively during the turn of the execution character).

Further, for example, when the home player and the other player have a follower relationship (i.e. when the other player is a follower of the home player) and a single attack is executed during the attack turn of an enemy character, the game management section 217:

(A) modifies an ability characteristic by which the execution character defends itself from the single attack to an ability characteristic by which the execution character can defend itself from consecutive attacks executed during the attack turn of the enemy character; or

(B) modifies an ability characteristic by which the execution character can defend itself from the attack executed during the attack turn of the enemy character with a probability of 50% to an ability characteristic by which the execution character can defend itself with a probability of 90%.

Note that when the execution parameter denotes an ability of the execution character or an overall ability of the plurality of player characters (the ability of the team set in the deck, for example), the “value at which an advantageous effect is acquired” indicates a value at which the ability increases, when the game parameter denotes the number of points, the “value at which an advantageous effect is acquired” indicates an increased number of points, and when the execution parameter indicates a winning probability, the “value at which an advantageous effect is acquired” indicates a value at which an increased probability is obtained.

Further, a friendship includes both a following relationship and a follower relationship, and therefore the game management section 217 may modify adjustment of the value of the execution parameter or variation of the ability characteristic of the execution character so as to be based on the following relationship or the follower relationship rather than the friendship.

### <When Execution Parameter Is Adjusted for Each Player>

For example, in the case envisaged below, the game parameter and the execution parameter are the number of points (gacha points) for executing a gacha in order to win a predetermined item (for example, an item that serves as a piece of equipment used in the game, a character card of a character appearing in the game, in-game currency, points, and so on) from among a plurality of items by lottery, and a player character of the home player or another player is selected.

In this case, when a player character x managed by the home player is selected from a plurality of player characters x, y, z displayed on an execution character setting screen, as illustrated in FIG. 7, the game management section 217 sets a value of “5”, defined as the gacha points of the player character x, as the number of gacha points (no adjustment).

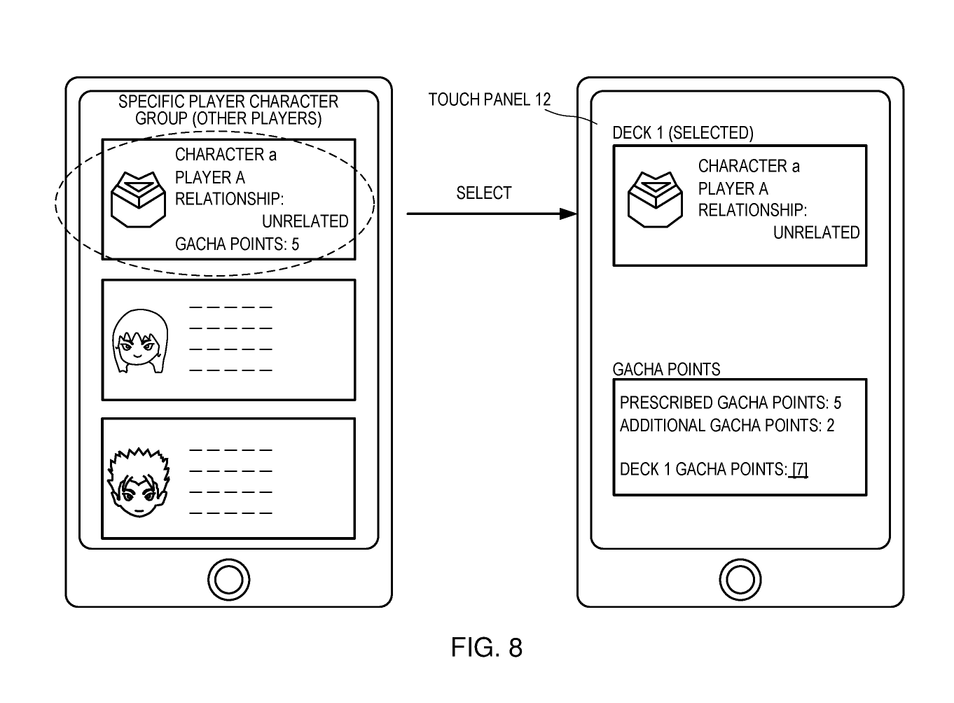

Further, when “unrelated” is indicated as the relationship information between the home player and another player A and a player character a managed by the other player in the unrelated condition is selected as an execution character, as illustrated in FIG. 8, the game management section 217 sets a value of “5”, defined as the gacha points of the player character a, as the execution parameter, and adjusts the number of gacha points by adding “+2” to this value.

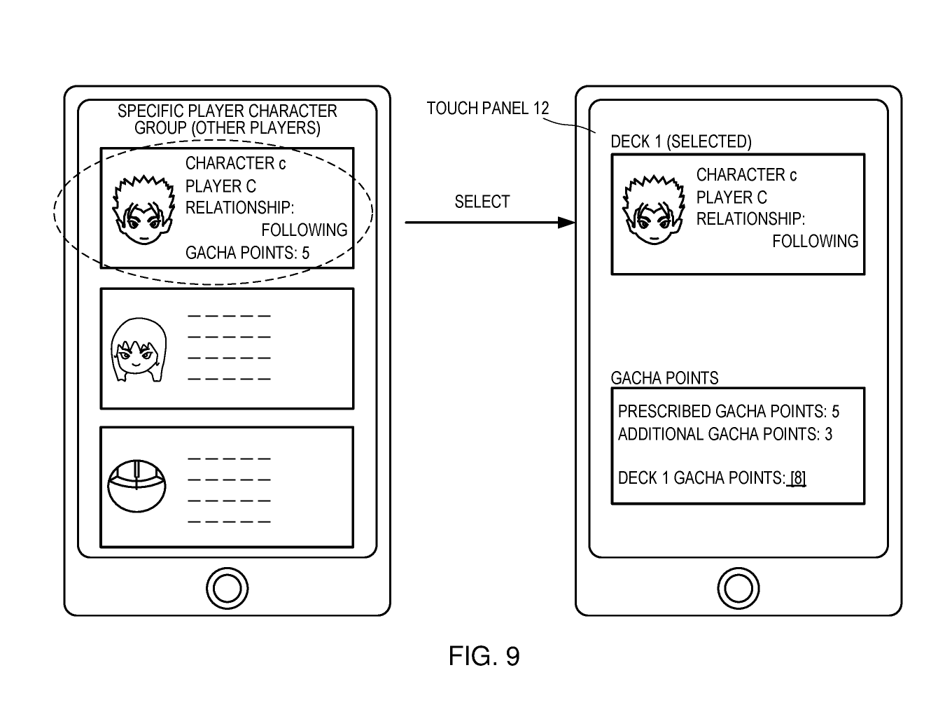

Furthermore, when “following” is indicated as the relationship information between the home player and another player C and a player character c managed by the other player in the following condition is selected as an execution character, as illustrated in FIG. 9, the game management section 217 sets a value of “5”, defined as the gacha points of the player character c, as the execution parameter, and adjusts the number of gacha points by adding “+3” to this value.

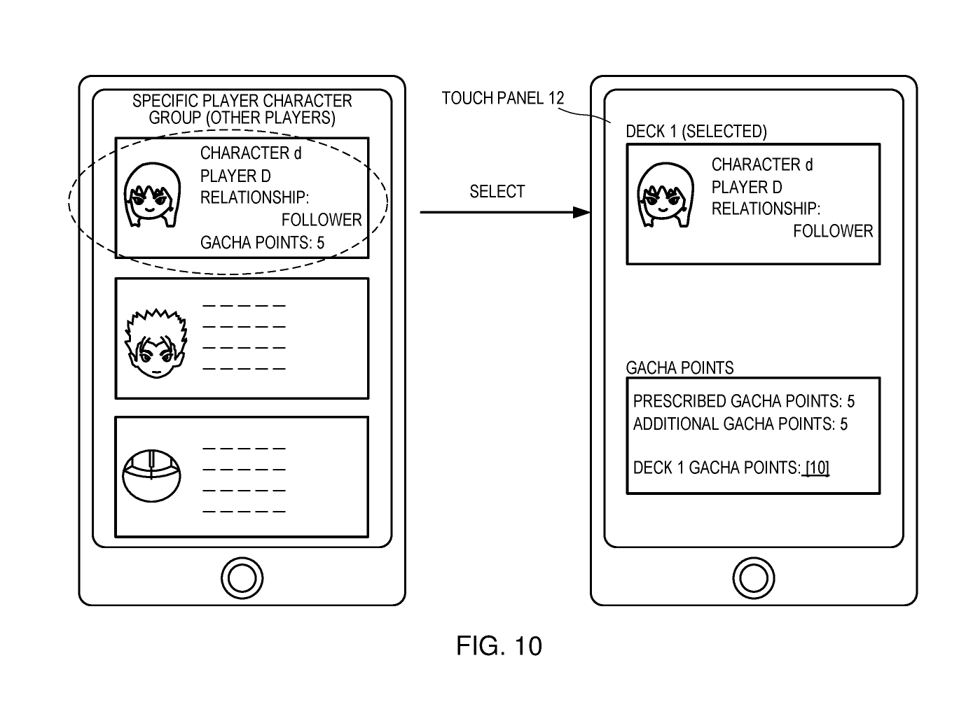

Moreover, when “follower” is indicated as the relationship information between the home player and another player D and a player character d managed by the other player in the follower condition is selected as an execution character, as illustrated in FIG. 10, the game management section 217 sets a value of “5”, defined as the gacha points of the player character d, as the execution parameter, and adjusts the number of gacha points by adding “+5” to this value.

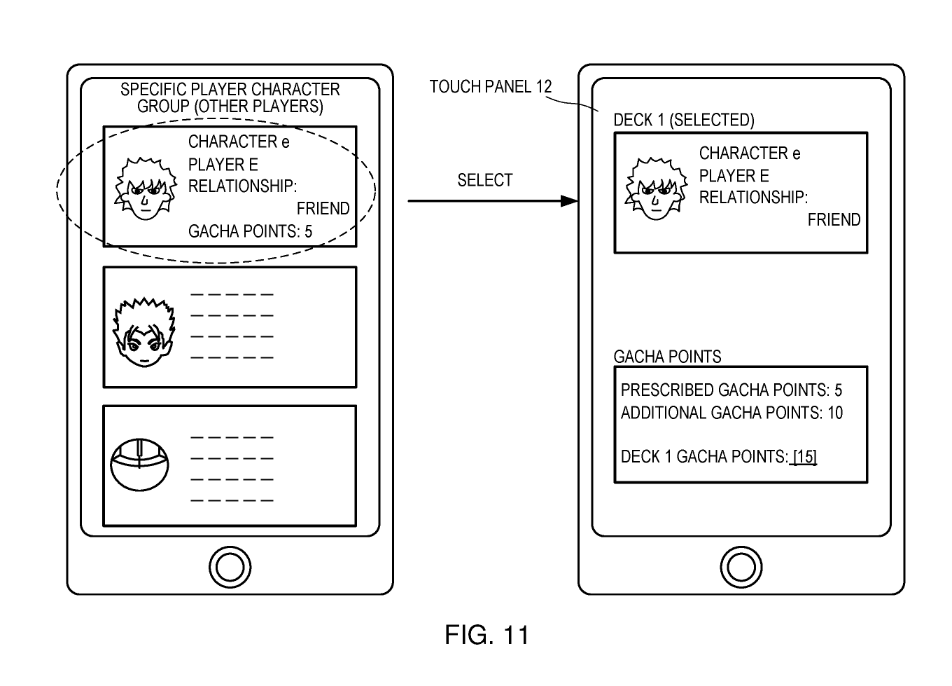

Further, when “friend” is indicated as the relationship information between the home player and another player E and a player character e managed by the other player in the friend condition is selected as an execution character, as illustrated in FIG. 11, the game management section 217 sets a value of “5”, defined as the gacha points of the player character c, as the execution parameter, and adjusts the number of gacha points by adding “+10” to this value.

### <When Execution Parameter Is Adjusted for Team as a Whole>

When the overall execution parameter of the team is set (adjusted) as the execution parameter, the game management section 217 aggregates numerical values (for example, a ratio of the relationship types) relating to the relationship information between the home player and the other players managing the specific player characters set as execution characters, and adjusts the execution parameter on the basis of the aggregation result.

For example, in a case envisaged below, the game parameter denotes a given ability such as attack such that the execution parameter denotes the attacking ability or the like of the entire team, one player character of the home player, two specific player characters of other players having relationship information indicating a following relationship, and one player character of another player having relationship information indicating a friendship have been selected, and the execution parameter is set on the basis of a ratio calculated according to the relationship types.

In this case, one other player has relationship information indicating a friendship, and therefore the game management section 217 calculates a component ratio of 25%, while two other players have relationship information indicating a following relationship, and therefore the game management section 217 calculates a component ratio of 50%.

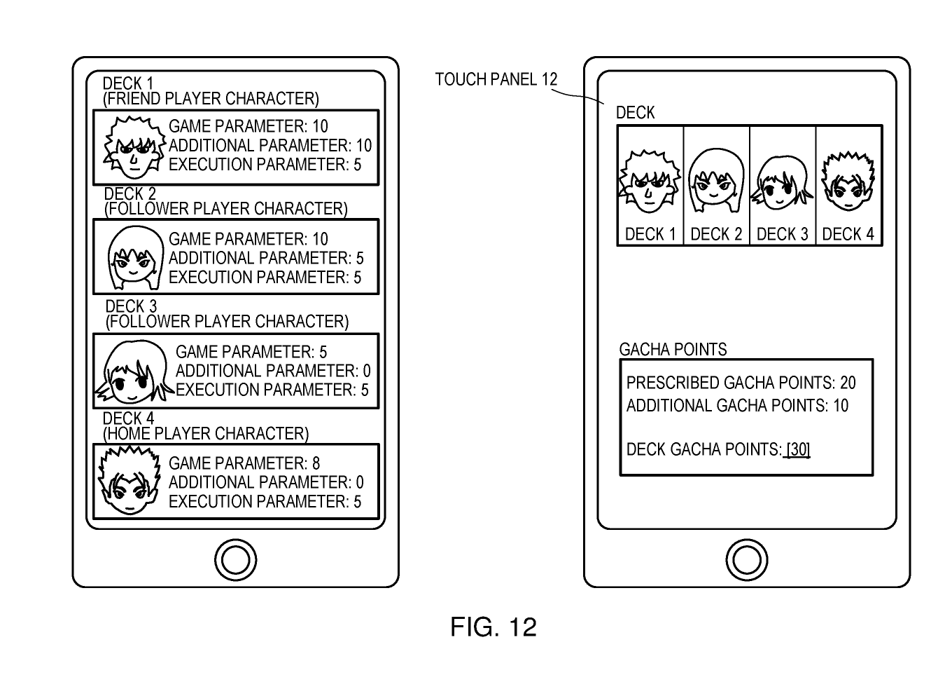

Assuming that a sum of the execution parameters prescribed in advance for the respective execution characters is 20 (i.e. each prescribed number of gacha points is 5), for example, as illustrated in FIG. 12, the game management section 217 adjusts the overall number of points of the team to a value of “30”, which serves as the value of the execution parameter, by adding “+10 (=20×0.25×2 (when the relationship is the friendship, the adding point is multiplied by 2))” points using the friendship component ratio of 25%, and adding “+10 (=20×0.5×1 (when the relationship is the following relationship, the adding point is multiplied by 1))” points using the following relationship component ratio of 50%.

Note that in this embodiment, an execution parameter is also set for the player whose specific player character is used, regardless of whether or not the deck has been set. In other words, the server device 10 monitors the parameter setting processing of each player, and when a specific player character of another player is set as an execution character by the setting processing, adjusts the execution parameter (suc as gacha points) of the other player by an identical number of points to that of the home player, for example, in accordance with the respective relationship conditions, namely the unrelated condition, the follower condition, the following condition, and the friend condition.

Further, as an execution parameter adjustment timing, the game management section 217 executes execution parameter adjustment when the deck is set (in other words, immediately), or at a predetermined timing such as 3 o'clock each day.

### <Relationship Establishment Period>

When a player character managed by another player (i.e. a specific player character) is selected as an execution character, the game management section 217 may adjust the execution parameter set in accordance with the game parameter prescribed in advance for each execution character on the basis of not only the relationship type, but also the period during which a relationship such as a follower relationship, a following relationship, or a friendship has been established.

More particularly, the game management section 217 is configured to:

(1) when a specific player character is selected as an execution character, obtain the period during which the relationship indicated by the relationship information used to set the execution parameter has been established on the basis of the supplementary information included in the relationship information; and

(2) adjust the value of the execution parameter on the basis of the relationship indicated by the relationship information and the obtained period.

More specifically, when a specific player character is selected as an execution character, the game management section 217 obtains the type information (specifically, unrelated, a follower relationship, a following relationship, or a friendship) included in the relationship information obtained with respect to the other player from the server device 10, and supplementary information (period information) indicating, with respect to the specific type of relationship (specifically, a follower relationship, a following relationship, or a friendship), the time at which the relationship was established (in other words, the time at which the subject relationship information was registered) and so on.

The game management section 217 then calculates the period (referred to hereafter as a “relationship establishment period”) during which the follower relationship, following relationship, friendship, or the like has been established on the basis of the obtained supplementary information and the current time, and on the basis of the relationship and the calculated relationship establishment period, adjusts the execution parameter of the relevant execution character (the specific player character selected as the execution character) or the execution parameter of the team formed from the player and the execution characters set in the deck.

Further, as the relationship establishment period lengthens, the game management section 217 adjusts the execution parameter to a value at which a more advantageous effect is acquired.

For example, when the game parameter and the execution parameter are gacha points, as described above, and a friendship with a relationship establishment period of two weeks is indicated, the game management section 217 sets the number of added gacha points to be larger than when the relationship establishment period is one week.

Note that in this embodiment, the time at which the relationship was established is registered as the supplementary information, and the game management section 217 calculates the relationship establishment period when adjusting the execution parameter, but instead, a relationship establishment period calculated in advance may be registered as the supplementary information at a predetermined timing.

### <Use of Game History>

When a player character managed by another player (i.e. a specific player character) is selected as an execution character, the game management section 217 may adjust the execution parameter set in accordance with the game parameter prescribed in advance for each execution character on the basis of not only the relationship type, but also the past player history with the other player with whom the relationship exists.

More particularly, the game management section 217 is configured to:

(1) when a specific player character is selected as an execution character, obtain the history information of the home player and the other player managing the specific player character from the server device 10; and

(2) adjust the value of the execution parameter on the basis of the relationship indicated by the relationship information and the playing history indicated by the obtained history information.

More specifically, when a specific player character is selected as an execution character, the game management section 217 obtains the type information (specifically, unrelated, a follower relationship, a following relationship, or a friendship) included in the relationship information indicating the relationship of the home player to the other player, and history information indicating the playing history of past games with the other player.

Further, on the basis of the obtained playing history information, the game management section 217 determines whether or not a given condition, such as a game having been executed cooperatively (in other words, whether or not the same game has been executed cooperatively) at least a predetermined number of times or a game having been executed using a player character of the other player at least a predetermined number of times, is satisfied.

Having determined that the given condition is satisfied, the game management section 217 adjusts the execution parameter of the relevant execution character (the specific player character selected as the execution character) or the execution parameter of the team formed from the player and the execution characters set in the deck.

For example, when a friendship is indicated and the above condition is satisfied in a case where the game parameter and the execution parameter are gacha points, as described above, the game management section 217 adjusts the number of gacha points by adding a predetermined number of points.

Note that in this embodiment, the given condition includes conditions such as the following:

(1) the other player logged into the game at least a predetermined time in the past;

(2) the total game playing time of the other player is at least a predetermined time;

(3) the home player participates in the same event as the other player at least a predetermined number of times;

(4) the home player contacts the other player during the game at least a predetermined number of times;

(5) the home player transmits a specific message (including a standard message such as “Good job!”) to the other player, or transmits a message at least a predetermined number of times;

(6) the home player receives a specific message from the other player, or receives a message at least a predetermined number of times; and

(7) a player character of the home player or the other player is used at least a predetermined number of times.

### <Others>

The game management section 217 may adjust the value of the execution parameter of a specific player character selected as an execution character on the basis of the number of players with whom the other player managing the specific player character has a specific relationship, such as the number of registered friends, followers, and so on.

More specifically, the game management section 217 may obtain the number of players with whom the other player managing the specific player character selected as an execution character has a specific relationship (a friendship, a follower relationship, or both) on the basis of the relationship information of the other player, and adjust the value of the execution parameter of the specific player character on the basis of the type of relationship between the home player and the other player and the obtained number of players.

Note that in this case, when different types of relationships are used as the number of players having the specific relationship that serves as the basis for adjusting the value of the execution parameter, a correction value such as doubling the number of players with respect to friendships may be employed.

Further, in this case, an adjustment range may be modified in accordance with the relationship type such that, for example, when the number of players having friendships is used, the number of players×5 points is added to the execution parameter value, and when the number of players having follower relationships is used, the number of players×2 points is added to the execution parameter value. Note, however, that the adjustment range is preferably reduced in order of friendship, follower relationship, and following relationship.

Alternatively, the game management section 217 may vary the game parameter that is subjected to adjustment or the adjusted numerical value range on the basis of the type of relationship (i.e., friendship, follower relationship, or following relationship) between the home player and the other player managing the specific player character set as an execution character in accordance with an attribute of the specific player character.

For example, an attribute such as water, fire, or earth may be set for each player character, and in a case where a specific player character having the water attribute is set as an execution character, the game management section 217 may adjust the execution parameter by a multiple of 10 when the relationship between the home player and the other player managing the specific player character is a friendship, and either adjust the execution parameter by a multiple of 2 or leave the execution parameter unadjusted such that the game parameter set for the specific player character is set as is as the execution parameter when the relationship is a follower relationship.

Further, for example, when an attribute such as water, fire, or earth and two or more game parameters, such as attacking power, defensive power, and gacha winning probability, are defined for each player character, the type of game parameter to be modified as the execution parameter may be varied in accordance with the relationship.

More specifically, when, in this case, the home player and the other player managing the specific player character have a friendship, the game management section 217 may adjust the attacking power game parameter as the execution parameter with respect to a specific player character that has the water attribute and is set as an execution character, and may adjust the gacha winning probability game parameter as the execution parameter with respect to a specific player character that has the fire attribute and is set as an execution character.

### 4.7 Display Control Processing

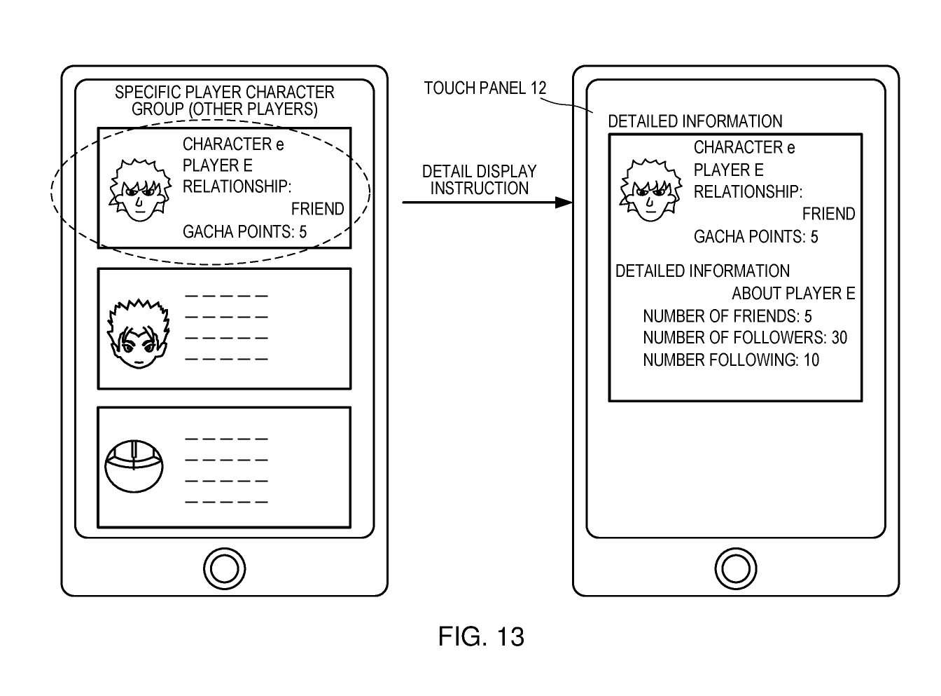

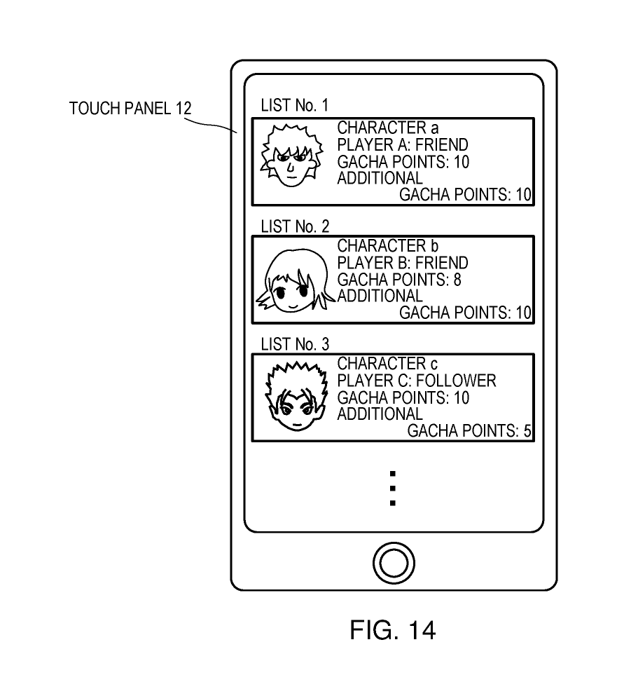

Next, using FIGS. 13 and 14, display control processing executed during the processing for selecting an execution player, the processing for registering the relationship information, and so on according to one embodiment of the invention will be described. Note that FIG. 13 illustrates display control processing executed in relation to the status information indicating the relationship between a player and another player, and FIG. 14 illustrates display control processing for sorting and displaying the relationship information on the basis of the execution parameter value.

When a player character of another player (i.e. a specific player character) is selected as an execution character to be set in the deck, or when relationship information with another player is registered by the registration processing described above, the display control section 212 executes display control processing for displaying, on the touch panel 12, the specific player character, the relationship information indicating the relationship between the other player manages the specific player character and the player who selects the specific player character or registers the relationship information, and the like.

### <Display of Relationship Information>

When the display control section 212 displays a specific player character of another player on the touch panel 12 in cases where a specific player character of another player is selected as an execution character, relationship information with another player is registered by the registration processing described above, and so on, the display control section 212 displays the relationship information indicating the relationship between the other player managing the specific player character and the player who issues an instruction to display the specific player character (the player who issues instructions to select the execution character and execute processing to register the relationship information) in a display area of the touch panel 12 in association with the specific player character.

For example, as illustrated in FIGS. 8 to 12, during selection processing for selecting a player character of another player (i.e. a specific player character) as an execution character to be set in the deck, the display control section 212 displays the relationship information indicating the relationship between the player selecting the specific player character and the other player managing the specific player character on the touch panel 12 as a part of the information relating to the specific player character.

Further, as illustrated in FIG. 13, for example, when a given instruction issued in relation to the specific player character of the other player is detected while the specific player character is displayed on the touch panel 12, the display control section 212 displays, on the touch panel 12, information indicating the statuses of the relationships of the other player managing the specific player character with different players (in other words, relationship status information), such as the number of players being followed by the other player, the number of players following the other player (i.e. the number of followers), and the number of friends.

FIG. 13 illustrates an example in which the number of players followed by and the number of followers of a player D managing a specific player character d are displayed.

Note that the given instruction may be an instruction issued by the player by performing an operation, or an instruction prescribed by the program (in other words, an instruction executed in accordance with the program) during the game processing, for example an instruction executed in order to progress the game such as a given action or event based on the game.

Further, the relationship status information may include, in addition to the above, information (the player ID, nickname, or the like) pertaining to the players having friendships, following relationships, and so on with the other player.

### <Sorting and Display Based on Execution Parameter Value>

When the display control section 212 displays a plurality of specific player characters of other players on the touch panel 12 in cases where a specific player character of another player is selected as an execution character, relationship information with another player is registered by the registration processing described above, and so on, the display control section 212 may sort the respective specific player characters and display the sorted specific player characters on the touch panel 12 in descending order of the adjusted value used as the execution parameter of each specific player character.

For example, as illustrated in FIG. 14, when a specific player character of another player is selected as an execution character, the display control section 212 displays a player character a having the largest adjusted execution parameter value in an uppermost display area of the display area of the touch panel 12, displays a player character b having the second largest adjusted execution parameter value in an area directly below the player character a in the display area of the touch panel 12, and then arranges and displays further specific player characters in order from top to bottom in descending order of the adjusted value.

Note that the display control section 212 displays the relationship information indicating the relationship between the player selecting the specific player character and the other player managing the specific player character on the touch panel 12 as a part of the information relating to the specific player character.

### <Others>

When a specific player character of another player is selected as an execution character, the display control section 212 may extract the other players who logged into the game most recently (for example, other players who logged in over the over the last two days), and display the specific player characters managed by the extracted other players on the touch panel 12 preferentially.

In particular, the display control section 212, in conjunction with the character management section 213, executes processing to:

(1) specify other players with respect to whom a time indicated by information indicating the login times of the other players stored in the server device 10 (in other words, game access time information (also referred to hereafter as “access time information”)) satisfies a given condition (whether or not the player logged into the game within the last two days);

(2) set the degree of priority of a specific player character managed by a specified other player to be higher than the degrees of priority of the specific player characters of the other players (i.e. the other players who do not satisfy the condition); and

(3) display the specific player characters on the game screen on the basis of the set degrees of priority.

Note that in this embodiment, the access time may be used as a basis for setting the degree of priority and executing sorting and display.

Meanwhile, when one specific player character is selected by an execution character deletion instruction, the display control section 212, in conjunction with the character management section 213, displays details of the selected specific player character on the game screen, and performs relationship registration or deletion, including relationship type modification, on the screen.

Note that when the type is modified by registering or deleting a relationship or the like, the display control section 212 executes relationship information registration or deletion in accordance therewith.

### 4.8 Modified Example

Next, a modified example of the embodiments of the invention will be described.

In this embodiment, each terminal device 20 sets a specific player character managed by another player as an execution character for executing the game with respect to each player, and advances the game using the set execution character (in other words, a ghost character), but instead of, or in addition to, a player character, an item such as a weapon or magic managed by another player may be set, and the game may be advanced using the set item.

### 5. Operation

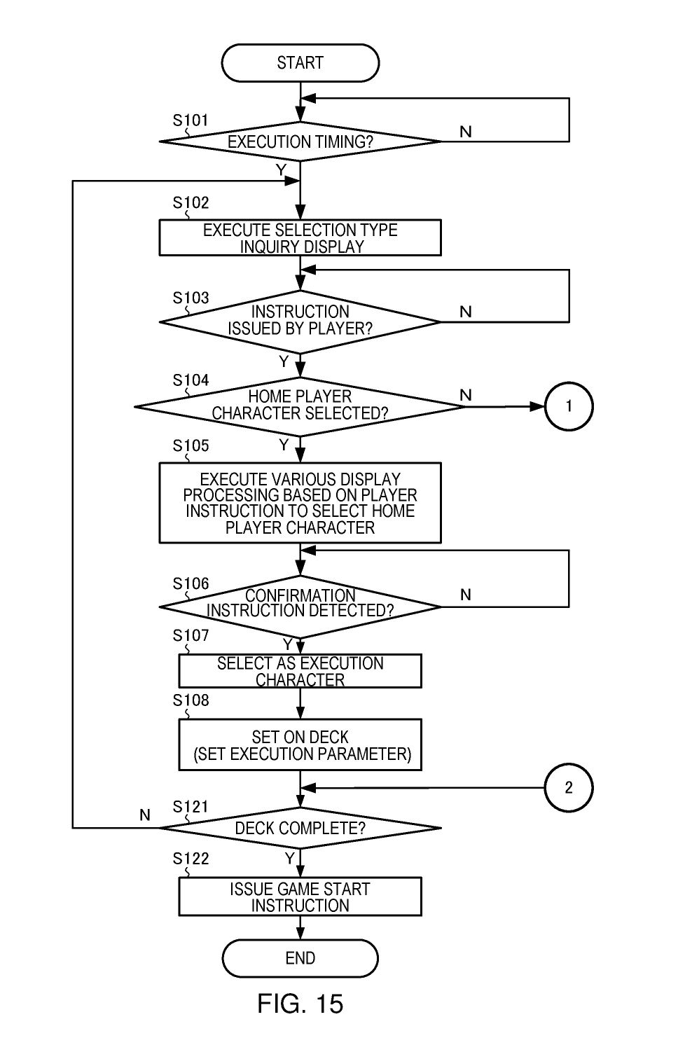

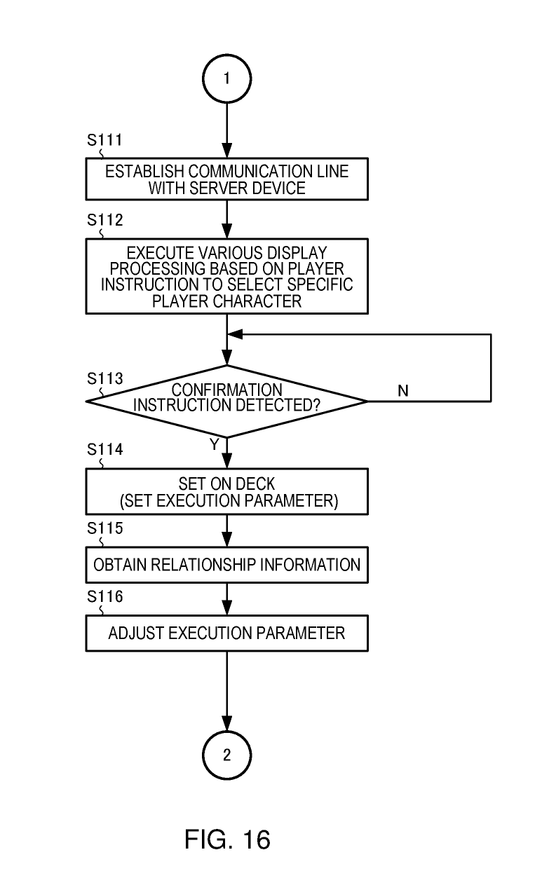

Next, using FIGS. 15 and 16, an operation performed during player character selection and setting processing, which is executed by the terminal device 20 to set a plurality of player characters in a deck, will be described. Note that FIGS. 15 and 16 are flowcharts illustrating the operation performed during the player character selection and setting processing executed by the terminal device 20 to set a plurality of player characters in the deck.

This operation is an operation for setting a plurality of player characters to be used in a game such as a battle game as execution characters in a deck before the game begins, and it is assumed that the execution characters are selected from among the home player characters and the specific player characters managed by the other players.

Further, in this operation, it is assumed that the information relating to each specific player character is obtained by the server device 10, while the information stored in the terminal device 20 is used as the information relating to the home player characters.

Furthermore, it is assumed that a battle game played by a plurality of player characters and a plurality of enemy characters, in which the characters take turns to attack in accordance with a predetermined order, is executed in conjunction with the operation.

First, when the character management section 213 detects a timing at which to execute the player character selection and setting processing for setting player characters in a deck via the game processing section 215 (step S101), the character management section 213 executes selection type inquiry display to ask the player whether a player character is to be selected from the player characters managed by the home player or from the specific player characters managed by the other players (step S102), and waits for an instruction from the player.

Next, when the character management section 213 detects an instruction from the player via the touch detection processing section 211 (step S103), the character management section 213 determines whether or not the instruction from the player is an instruction to select a player character from the player characters managed by the home player (step S104).

When the character management section 213 determines at this time that the instruction from the player is an instruction to select a player character from the player characters managed by the home player, the processing advances to step S105, and when the character management section 213 determines that the instruction from the player is not an instruction to select a player character from the player characters managed by the home player (in other words, when the instruction from the player is an instruction to select a player character from the specific player characters managed by the other players), the processing advances to step S111.

Next, having determined that the instruction from the player is an instruction to select a player character from the player characters managed by the home player, the character management section 213, in conjunction with the touch detection processing section 211 and the display control section 212, displays the list of player characters that can be selected as execution characters, which is stored in the player information 273 (including display based on groups and search keys), or executes various types of display processing such as displaying the details of the individual player characters (step S105), and waits for a confirmation instruction from the player.

Next, having detected a confirmation instruction from the player (step S106), the character management section 213 selects the player character specified by the confirmation instruction as an execution character (step S107).

Next, the game management section 217 reads various information pertaining to the selected player character, including the game parameter, from the player information 273, and sets the selected player character in the deck, which includes setting the value of the game parameter at the execution parameter value (step S108). The processing then advances to step S121.

When, on the other hand, the character management section 213 determines that the instruction from the player is not an instruction to select a player character from the player characters managed by the home player (in other words, when the instruction from the player is an instruction to select a player character from the specific player characters managed by the other players), the character management section 213 establishes a communication line with the server device 10 via the communication section 296 (step S111).

Next, the character management section 213, in conjunction with the server device 10, the touch detection processing section 211, and the display control section 212, displays a list of the specific player characters managed by the other players (including display based on groups and search keys) or executes various types of display processing such as displaying the details of the individual player characters, and waits for a confirmation instruction from the player (step S112).

Next, having detected a confirmation instruction from the player (step S112), the character management section 213 selects the specific player character specified by the confirmation instruction as an execution character (step S113).

Next, the game management section 217 reads various information pertaining to the selected specific player character, including the game parameter, from the server device 10, and sets the selected specific player character in the deck, which includes setting the value of the game parameter at the execution parameter value (step S114).

Next, the game management section 217, in conjunction with the server device 10, identifies the other player managing the specific player character selected as the execution character, and obtains the relationship information indicating the relationship between the specified other player and the home player (step S115).

Next, the game management section 217 identifies the relationship between the other player and the home player on the basis of the obtained relationship information, and adjusts the value of the execution parameter on the basis of the identified relationship (step S116). The processing then advances to step S121.

Next, the character management section 213 determines whether or not all of the player characters to be set in the deck have been set (in other words, whether or not the deck is complete) (step S121). When the character management section 213 determines at this time that all of the player characters have not been set, the processing advances to step S102, and when the character management section 213 determines that all of the player characters have been set, the processing advances to step S122.

Next, the game processing section 215 issues an instruction to start a game based on the execution players set in the deck (step S122), whereupon the operation is terminated.

### 6. Others

Note that the invention is not limited to the embodiments described above, and thus it can be implemented in many various ways. Any term cited with a different term having a broader meaning or the same meaning at least once in the specification and the drawings may be replaced by the different term in any place in the specification and the drawings.

In the above embodiments, operation input for a battle game or a sport game was described, but the operation input may be used for another game, such as an RPG or a simulation game.

Further, the invention is not limited to a game, and may be applied to any configuration in which touch operation input and sliding operation input are used as a user interface.

Furthermore, in the above embodiments, games may be provided to the terminal devices 20 by the single server device 10, or a server system may be constructed by having a plurality of server devices 10 operate in conjunction, and games may be provided to the terminal devices 20 by the server system.

The invention includes various other configurations substantially the same as the configurations described in connection with the above embodiments (for example, a configuration having the same function, method, and results, or a configuration having the same objectives and effects). The invention also includes a configuration in which an unsubstantial section (element) described in connection with the above embodiments is replaced by another section (element). The invention also includes a configuration having the same effects as those of the configurations described in connection with the above embodiments, or a configuration capable of achieving the same objectives as that of the configurations described in connection with the above embodiments. The invention further include a configuration in which a known technique is added to the configurations described in connection with the above embodiments.

Although only some embodiments of the invention have been described in detail above, a person skilled in the art would readily appreciate that many modifications are possible in the embodiments without materially departing from the novel teachings and advantages of the invention. Accordingly, all such modifications are intended to be included in the scope of the invention.

What is claimed is:

1. A game system for executing a game using a relationship between a player and another player, the game system comprising:
management means for managing storage means, the storage means storing, for each player, relationship information indicating the relationship of the player to the other player, and player character information which is information relating to player characters that can be used by each player in the game and respectively have given game parameter values prescribed thereto;
selecting means for executing selection processing to select, on the basis of an instruction from the player, a player character to be used in the game as an execution character from among a plurality of player characters that are stored in the storage means and can be used by the player, the plurality of player characters including, as a specific player character, a player character that is managed by the other player;
setting means for setting the game parameter value stored for each selected execution character at a given game parameter value for executing the game, and using the set game parameter value as an execution parameter value; and
game control means for executing the game on the basis of the set plurality of execution characters and the set execution parameter values thereof,
wherein the relationship with the other player includes a following relationship, which is a relationship in which predetermined information or statuses relating to the other player can be viewed as a function of the game, and a follower relationship, which is a relationship in which the other player is allowed to view predetermined information or statuses relating to a home player as a function of the game, and
wherein, when the specific player character is selected as the execution character, the setting means adjusts the execution parameter value on the basis of the relationship information indicating the following relationship or the follower relationship between the home player who is the player who issues the selection instruction during the selection processing, and the other player managing the specific player character.

2. The game system according to claim 1,
wherein the execution parameter is a game parameter relating to the specific player character selected as the execution character.

3. The game system according to claim 1,
wherein, when the specific player character is selected as the execution character, the setting means aggregates given numerical values relating to the following relationship or the follower relationship between the player and the other player managing the specific player character set as the execution character, the following relationship or the follower relationship being stored in the storage means, and adjusts the execution parameter on the basis of the aggregation result.

4. The game system according to claim 1,
wherein the relationship information includes supplementary information for obtaining a period in which the following relationship or the follower relationship has been established, and
wherein, when the specific player character is selected as the execution character, the setting means obtains the supplementary information relating to the following relationship or the follower relationship between the home player and the other player managing the specific player character, obtains the period in which the relationship has been established on the basis of the obtained supplementary information, and adjusts the execution parameter value on the basis of the relationship indicated by the relationship information and the obtained period.

5. The game system according to claim 1,
wherein the storage means stores, for each player, history information indicating a past playing history with other players having the following relationship or the follower relationship with each player, and
wherein, when the specific player character is selected as the execution character, the setting means obtains the history information between the home player and the other player managing the specific player character, and adjusts the execution parameter value on the basis of the following relationship or the follower relationship and the playing history indicated by the history information.

6. The game system according to claim 1, further comprising:
specifying means for executing specification processing at a given timing on the basis of history information relating to games of each of the players, the history information being stored in the storage means, to specify another player who satisfied a given condition during a past game with a relevant player; and
registering/updating means for registering or updating the relationship information indicating the relationship between the home player and the other player who satisfied the given condition in the storage means as the following relationship in accordance with the given condition.

7. The game system according to claim 1, further comprising display control means for displaying a plurality of specific player characters on a game screen on the basis of a given instruction,
wherein the display control means sorts the plurality of specific player characters in descending order of an adjusted value of the execution parameter of each specific player character, and displays the plurality of sorted specific player characters on the game screen.

8. The game system according to claim 1, further comprising display control means for displaying, on a game screen, the relationship information indicating the relationship between the player and the other player managing the specific player character in association with the specific player character.

9. The game system according to claim 8,
wherein, when a given instruction issued in relation to the specific player character is detected, the display control means displays, on the game screen, information relating to a status of the relationship of the other player managing the specific player character.

10. The game system according to claim 1,
wherein, when the specific player character is selected as the execution character, the setting means adjusts the execution parameter value which relates to an ability of the specific player character, in accordance with the following relationship or the follower relationship between the home player and the other player managing the specific player character.

11. The game system according to claim 1,
wherein, when the specific player character is selected as the execution character, the setting means varies a characteristic relating to an ability of the execution character which is determined by the execution parameter, in accordance with the following relationship and the follower relationship between the home player and the other player managing the specific player character.

12. The game system according to claim 1,
wherein the setting means obtains the number of players having the following relationship or the follower relationship with the other player managing the specific player character selected as the execution character, and adjusts the execution parameter value which relates to an ability of the specific player character, in accordance with the relationship type, namely the following relationship or the follower relationship, and the obtained number of players.

13. The game system according to claim 1,
wherein, when two or more game parameters defining abilities of the specific player character are set for the specific player character, the setting means determines a game parameter to be adjusted as the execution parameter from the two or more game parameters in accordance with the relationship type, namely the following relationship or the follower relationship, of the relationship between the home player and the other player managing the specific player character set as the execution character.

14. The game system according to claim 1,
wherein a time at which each player executed a game is stored in the storage means as access time information, and
wherein, when the specific player character is selected as the execution character, the setting means specifies another player with respect to whom the time indicated by the access time information satisfies a given condition, sets a degree of priority of the specific player character managed by the specified other player to be higher than a degree of priority of another specific player character, and displays the specific player characters on a game screen on the basis of the set degrees of priority.

15. A method for executing a game using a relationship between a player and another player, the method comprising:
managing storage means, the storage means storing, for each player, relationship information indicating the relationship of the player to the other player, and player character information which is information relating to player characters that can be used by each player in the game and respectively have given game parameter values prescribed thereto;
executing selection processing to select, on the basis of an instruction from the player, a player character to be used in the game as an execution character from among a plurality of player characters that are stored in the storage means and can be used by the player, the plurality of player characters including, as a specific player character, a player character that is managed by the other player;
setting the game parameter value stored for each selected execution character at a given game parameter value for executing the game, and using the set game parameter value as an execution parameter value; and
executing the game on the basis of the set plurality of execution characters and the set execution parameter values thereof,
wherein the relationship with the other player includes a following relationship which is a relationship in which predetermined information or statuses relating to the other player can be viewed as a function of the game, and a follower relationship which is a relationship in which the other player is allowed to view predetermined information or statuses relating to a home player as a function of the game, and
wherein, when the specific player character is selected as the execution character, the execution parameter value is adjusted on the basis of the relationship information indicating the following relationship or the follower relationship between the home player who is the player who issues the selection instruction during the selection processing, and the other player managing the specific player character.
